(19) United States
(12) Patent Application Publication
(10) Pub. No.: US 2026/0202285 A1
(43) Pub. Date: Jul. 16, 2026

(54) GAS MEASURING DEVICE, GAS MEASURING SYSTEM, AND GAS MEASURING METHOD

(71) Applicant: SONY GROUP CORPORATION, TOKYO (JP)

(72) Inventors: MITSUHIRO KAWANISHI, TOKYO (JP); MASAKAZU UKITA, TOKYO (JP); SHOGO WAKAZAKI, TOKYO (JP); KAZUHIKO MIYAHARA, TOKYO (JP); TAIKI SUGIYAMA, TOKYO (JP); YUICHI ISHIDA, TOKYO (JP); MICHIKO NAKAO, TOKYO (JP); TOSHIO NISHI, TOKYO (JP)

(21) Appl. No.: 19/135,370

(22) PCT Filed: Nov. 8, 2023
(86) PCT No.: PCT/JP2023/040306

§ 371 Date: Jun. 3, 2025

(30) Foreign Application Priority Data
Dec. 8, 2022 (JP) 2022-196195

(51) Int. Cl. G01N 1/24; G01N 1/22; G01N 1/34; G01N 27/12

(52) U.S. Cl. CPC G01N 1/24; G01N 1/2273; G01N 1/34; G01N 27/125

(57) ABSTRACT

A gas measuring device according to an aspect of the present disclosure includes a first flow channel, a second flow channel, a first branched flow channel, and a second branched flow channel. The first flow channel includes a first three-way valve with one input and two outputs, a gas detector coupled to a first output of the first three-way valve, and a first pump coupled to the first output or an input of the first three-way valve. The second flow channel includes a second three-way valve with one input and two outputs and a second pump coupled to a first output or an input of the second three-way valve. The first branched flow channel is coupled to a second output of the first three-way valve and the first output of the second three-way valve. The second branched flow channel is coupled to a second output of the second three-way valve and the first output of the first three-way valve.

### TECHNICAL FIELD

The present disclosure relates to a gas measuring device, a gas measuring system, and a gas measuring method.

### BACKGROUND ART

In recent years, a gas measuring device using a sensor element has been developed (See, for example, PTL 1).

### CITATION LIST

### Patent Literature

PTL 1: Japanese Unexamined Patent Application Publication No. 2001-13098

### SUMMARY OF THE INVENTION

Incidentally, a gas measuring device is required to measure a target component in a gas with good accuracy. It is desired to provide a gas measuring device, a gas measuring system, and a gas measuring method that make it possible to measure the target component in the gas with good accuracy.

A gas measuring device according to a first aspect of the present disclosure includes a first flow channel, a second flow channel, a first branched flow channel, and a second branched flow channel. The first flow channel includes a first three-way valve with one input and two outputs, a gas detector coupled to a first output of the first three-way valve, and a first pump coupled to the first output or an input of the first three-way valve. The second flow channel includes a second three-way valve with one input and two outputs and a second pump coupled to a first output or an input of the second three-way valve. The first branched flow channel is coupled to a second output of the first three-way valve and the first output of the second three-way valve. The second branched flow channel is coupled to a second output of the second three-way valve and the first output of the first three-way valve.

A gas measuring system according to a second aspect of the present disclosure includes a first flow channel, a second flow channel, a first branched flow channel, and a second branched flow channel. The first flow channel includes a first three-way valve with one input and two outputs, a gas detector coupled to a first output of the first three-way valve, and a first pump coupled to the first output or an input of the first three-way valve. The second flow channel includes a second three-way valve with one input and two outputs and a second pump coupled to a first output or an input of the second three-way valve. The first branched flow channel is coupled to a second output of the first three-way valve and the first output of the second three-way valve. The second branched flow channel is coupled to a second output of the second three-way valve and the first output of the first three-way valve. This gas measuring system further includes a signal processor that processes a detection signal of the gas detector.

A gas measuring method according to a third aspect of the present disclosure includes the following three:
(A1) A first sensing step, in which in a first three-way valve with one input and two outputs, the input of the first three-way valve is caused to communicate with a first output of the first three-way valve, and in a second three-way valve with one input and two outputs, the input of the second three-way valve is caused to communicate with a first output of the second three-way valve. Then, by action of a first pump, a first gas is drawn through the first three-way valve into a first flow channel including a gas sensor, and by action of a second pump, a second gas is drawn through the second three-way valve into a second flow channel;
(A2) A second sensing step, in which in the first three-way valve, the input of the first three-way valve is caused to communicate with a second output of the first three-way valve, and in the second three-way valve, the input of the second three-way valve is caused to communicate with a second output of the second three-way valve. Then, by the action of the second pump, the first gas is drawn through the first three-way valve into the second flow channel, and by the action of the first pump, the second gas is drawn through the first three-way valve into the first flow channel; and
(A3) Alternately performing the first sensing step and the second sensing step by opening and closing the first three-way valve and the second three-way valve.

A fourth aspect of the present disclosure includes the following three:
(B1) A first sensing step, in which in a first three-way valve with one input and two outputs, the input of the first three-way valve is caused to communicate with a first output of the first three-way valve, and in a second three-way valve with one input and two outputs, an input of the second three-way valve is caused to communicate with a first output of the second three-way valve, and then, a first gas drawn by action of a first pump flows through the first three-way valve into a first flow channel including a gas sensor, and a second gas drawn by action of a second pump flows through the second three-way valve into a second flow channel;
(B2) A second sensing step, in which in the first three-way valve, the input of the first three-way valve is caused to communicate with a second output of the first three-way valve, and in the second three-way valve, the input of the second three-way valve is caused to communicate with a second output of the second three-way valve. Then, the first gas drawn by the action of the first pump flows through the first three-way valve into the second flow channel, and the second gas drawn by the action of the second pump flows through the first three-way valve into the first flow channel; and
(B3) Alternately performing the first sensing step and the second sensing step by opening and closing the first three-way valve and the second three-way valve.

In the gas measuring device according to the first aspect of the present disclosure, and the gas measuring system according to the second aspect of the present disclosure, the first flow channels including the first three-way valves and the second flow channel including the second three-way valves are provided. In the gas measuring device and the gas measuring system are further provided the first branched flow channels coupled to the second output of the first three-way valve and the first output of the second three-way valve as well as the second branched flow channels coupled to the second output of the second three-way valve and the first output of the first three-way valve. This makes it possible to alternately flow the gas flowing through the first three-way valves and the gas flowing into the second three-way valves to the gas detectors without stopping flow of both of the gases, by switching between opening and closing the first three-way valves and the second three-way valves. As a result, it becomes possible to suppress generation of noise when switching between two types of gases.

In the gas measuring method according to the third aspect of the present disclosure, a base gas is drawn through the first three-way valve into the first flow channel including the gas sensor by the action of the first pump, and an evaluation gas is drawn through the second three-way valve into the second flow channel by the action of the first pump. Furthermore, in this gas measuring method, the base gas is drawn through the first three-way valve into the second flow channel by the action of the second pump, and the evaluation gas is drawn through the first three-way valve into the first flow channel by the action of the first pump. This makes it possible to alternately flow the base gas flowing through the first three-way valves and the evaluation gas flowing into the second three-way valves to the gas detectors without stopping flow of both of the gases, by switching between opening and closing the first three-way valves and the second three-way valves. As a result, it becomes possible to suppress the generation of noise when switching between the base gas and the evaluation gas.

In the gas measuring method according to the fourth aspect of the present disclosure, the base gas drawn by the action of the first pump flows through the first three-way valve into the first flow channel including the gas sensor, and the evaluation gas drawn by the action of the second pump flows through the second three-way valve into the second flow channel. In this gas measuring method, the base gas drawn by the action of the first pump flows through the first three-way valve into the second flow channel, and the evaluation gas drawn by the action of the second pump flows through the first three-way valve into the first flow channel. This makes it possible to alternately flow the base gas flowing through the first three-way valves and the evaluation gas flowing into the second three-way valves to the gas detectors without stopping flow of both of the gases, by switching between opening and closing the first three-way valves and the second three-way valves. As a result, it becomes possible to suppress the generation of noise when switching between the base gas and the evaluation gas.

### BRIEF DESCRIPTION OF DRAWING

FIG. 1 is an appearance diagram illustrating a configuration example of a gas measuring device according to a first embodiment of the present disclosure.

FIG. 2 is a diagram illustrating examples of functional blocks of the gas measuring device illustrated in FIG. 1.

FIG. 3A is a diagram illustrating a configuration example of a top surface of a gas sensor.

FIG. 3B is a diagram illustrating a configuration example of a rear surface of the gas sensor.

FIG. 4 is a diagram illustrating a circuit configuration example of a sensor unit.

FIG. 5 is a diagram illustrating an example of flow channels of two three-way electromagnetic valves in the gas measuring device in FIG. 2.

FIG. 6 is a diagram illustrating an example of the flow channels of the two three-way electromagnetic valves in the gas measuring device in FIG. 2.

FIG. 7 is a diagram illustrating an example of a gas measuring procedure in the gas measuring device.

FIG. 8 is a diagram illustrating an example of a detection signal (sensor resistance value) of a sensor unit and an example of states of the two three-way electromagnetic valves.

FIG. 9 is a diagram illustrating an example of a detection signal (sensor resistance value) and an example of a state of one three-way electromagnetic valve in a gas measuring device according to a comparative example.

FIG. 10 is a diagram illustrating an example of a sensor resistance value when refreshing of a gas sensor is performed in a gas measuring device.

FIG. 11 is a diagram illustrating an example of a sensor resistance value when refreshing is performed at two different temperatures.

FIG. 12 is a diagram illustrating a modification example of functional blocks of a gas measuring device.

FIG. 13 is a diagram illustrating a modification example of the functional blocks of the gas measuring device.

FIG. 14 is a diagram illustrating a modification example of the functional blocks of the gas measuring device.

FIG. 15 is a diagram illustrating an example of flow channels of two three-way electromagnetic valves in the gas measuring device in FIG. 14.

FIG. 16 is a diagram illustrating an example of the flow channels of the two three-way electromagnetic valves in the gas measuring device in FIG. 14.

FIG. 17 is a diagram illustrating a modification example of the functional blocks of the gas measuring device in FIG. 2.

FIG. 18 is a diagram illustrating a modification example of the functional blocks of the gas measuring device in FIG. 2.

FIG. 19 is a diagram illustrating a modification example of the functional blocks of the gas measuring device in FIG. 2.

FIG. 20 is a diagram illustrating a modification example of the functional blocks of the gas measuring device in FIG. 2.

FIG. 21 is a diagram illustrating a modification example of the functional blocks of the gas measuring device in FIG. 2.

FIG. 22 is a diagram illustrating a modification example of functional blocks of a gas measuring device.

FIG. 23 is a diagram illustrating an example of the flow channels of the two three-way electromagnetic valves in the gas measuring device in FIG. 22.

FIG. 24 is a diagram illustrating an example of the flow channels of the two three-way electromagnetic valves in the gas measuring device in FIG. 22.

FIG. 25 is a diagram illustrating a modification example of functional blocks of a gas measuring device.

FIG. 26 is a diagram illustrating an example of the flow channels of the two three-way electromagnetic valves in the gas measuring device in FIG. 25.

FIG. 27 is a diagram illustrating an example of the flow channels of the two three-way electromagnetic valves in the gas measuring device in FIG. 25.

FIG. 28 is a diagram illustrating an application example of the described gas measuring device.

FIG. 29 is a diagram illustrating a functional block example of a server device.

FIG. 30 is a diagram illustrating a modification example of some functional blocks of the gas measuring device in FIG. 1.

FIG. 31 is a diagram illustrating a modification example of some functional blocks of the gas measuring device in FIG. 1.

FIG. 32 is a diagram illustrating an example of a detection signal (sensor resistance value) of a sensor unit and an example of states of three three-way electromagnetic valves.

FIG. 33 is a diagram illustrating an example of a sensor resistance value and an example of a state of a three-way electromagnetic valve when refreshing of a gas sensor is performed in a gas measuring device.

FIG. 34 is a diagram illustrating a modification example of some of the functional blocks of the gas measuring device in FIG. 1.

FIG. 35 is a diagram illustrating an example of a detection signal (sensor resistance value) of a sensor unit and an example of states of four two-way electromagnetic valves.

FIG. 36 is a diagram illustrating an example of a sensor resistance value and an example of the states of the four two-way electromagnetic valves when refreshing of a gas sensor is performed in a gas measuring device.

FIG. 37 is a diagram illustrating a modification example of the functional blocks of the gas measuring device in FIG. 1. Modes for Carrying Out the Invention

In the following, some embodiments for carrying out the present disclosure will be described in detail with reference to the drawings. It is to be noted that the description will be given in the following order.

### 1. EMBODIMENT

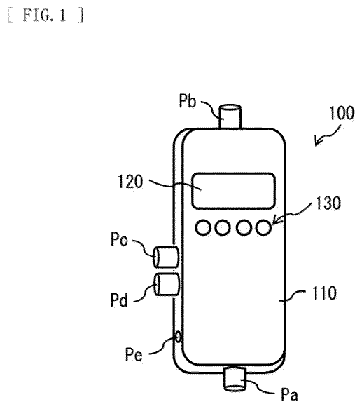

An example of switching between a base gas and an evaluation gas by opening and closing two three-way valves (FIG. 1 to FIG. 9)

### 2. MODIFICATION EXAMPLES

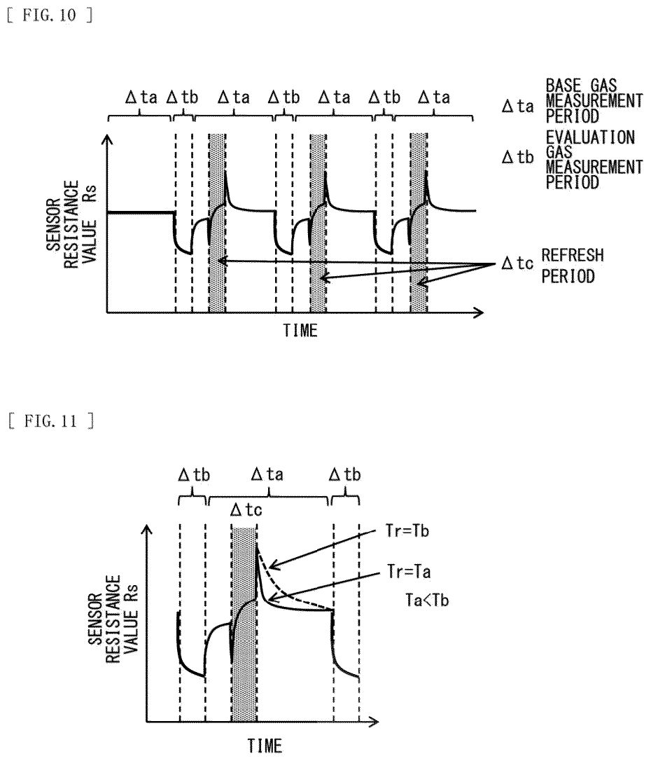

Modification Example A: An example in which refreshing of a gas sensor is provided (FIG. 10 and FIG. 11)

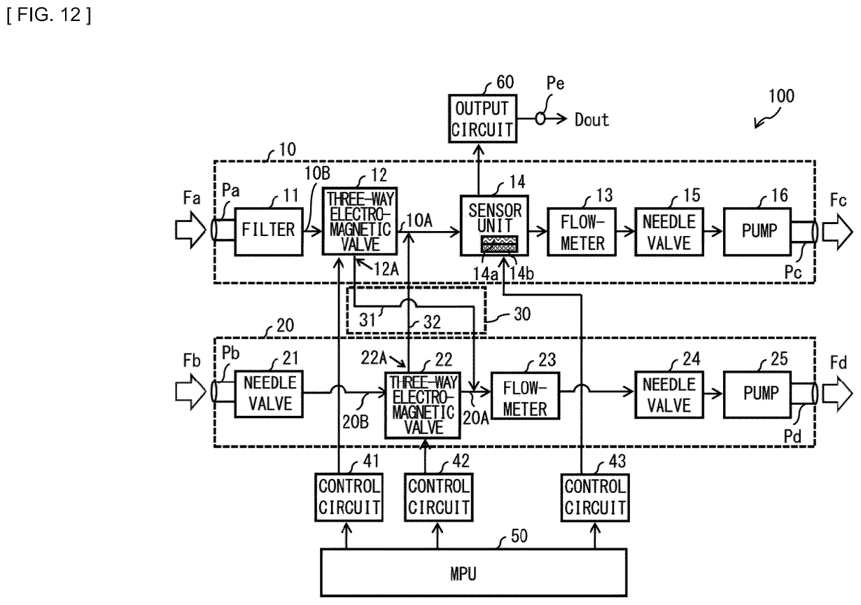

Modification Example B: An example in which a flowmeter is provided at the rear of a sensor unit (FIG. 12)

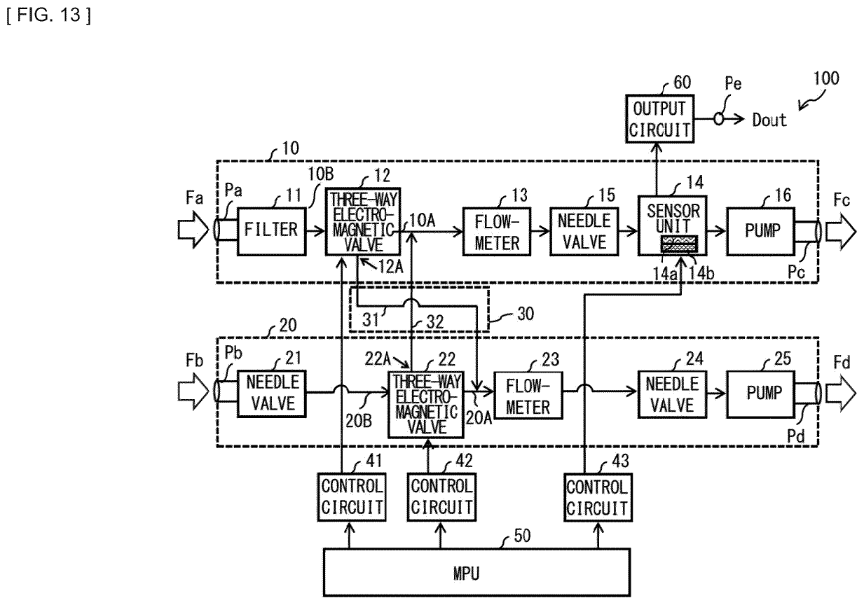

Modification Example C: An example in which a sensor unit is provided at the rear of a needle valve (FIG. 13)

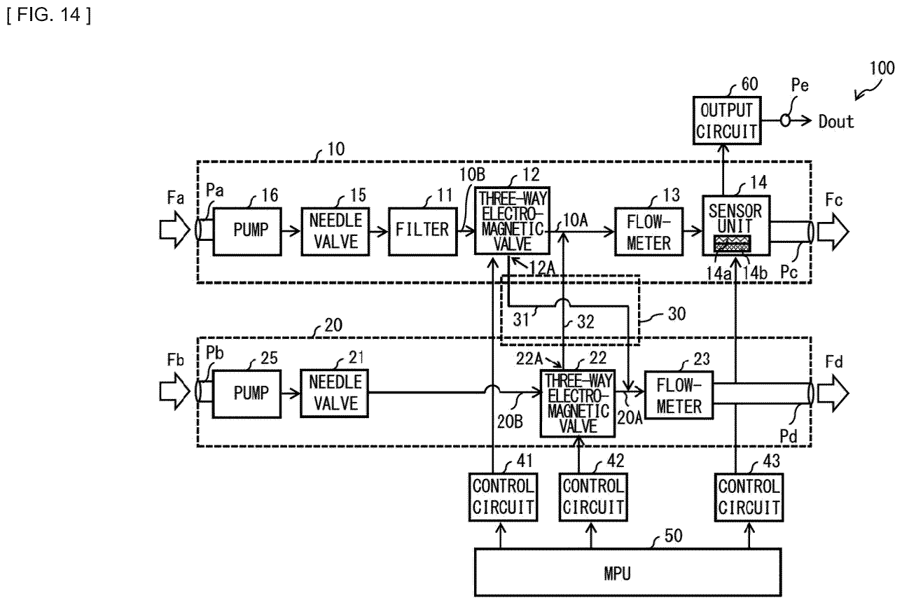

Modification Example D: An example in which a pump is provided at the front end (FIG. 14 to FIG. 16)

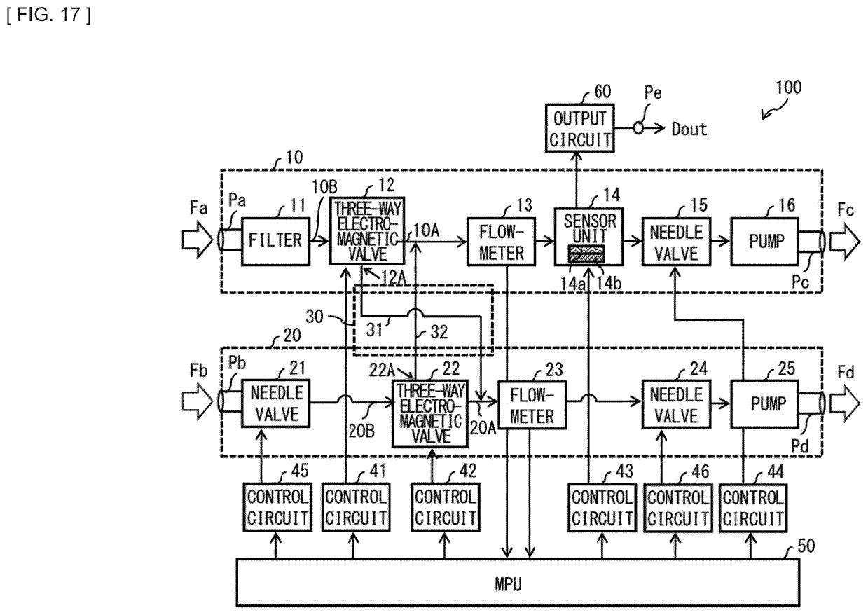

Modification Example E: An example in which a needle valve is controlled on the basis of measurement data of a flowmeter (FIG. 17)

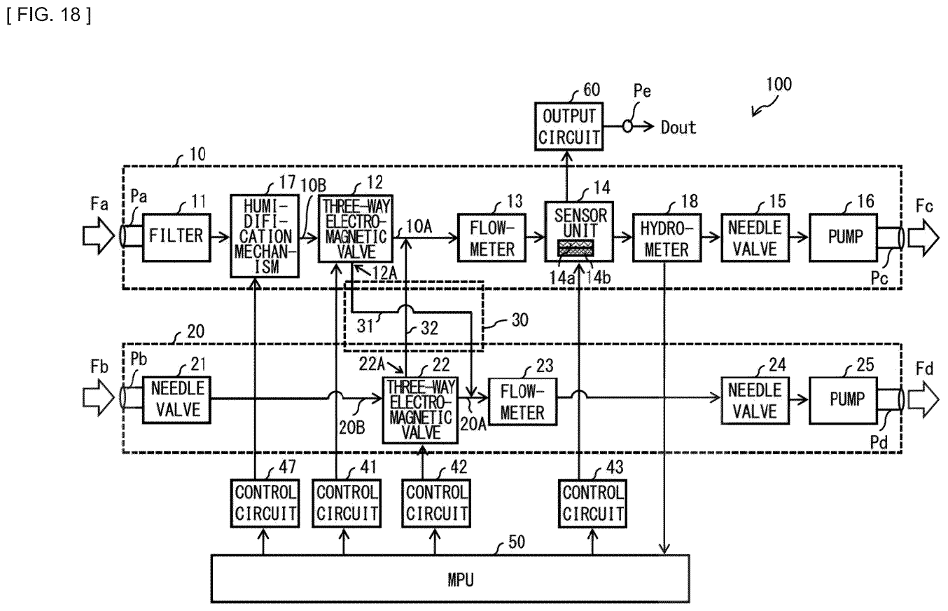

Modification Example F: An example in which moisture is controlled (FIG. 18)

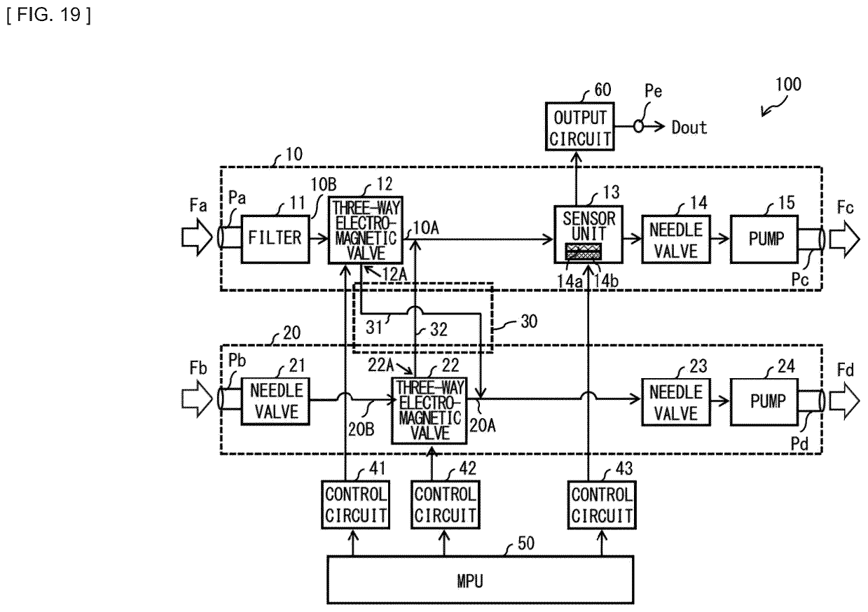

Modification Example G: An example in which a flowmeter is omitted (FIG. 19)

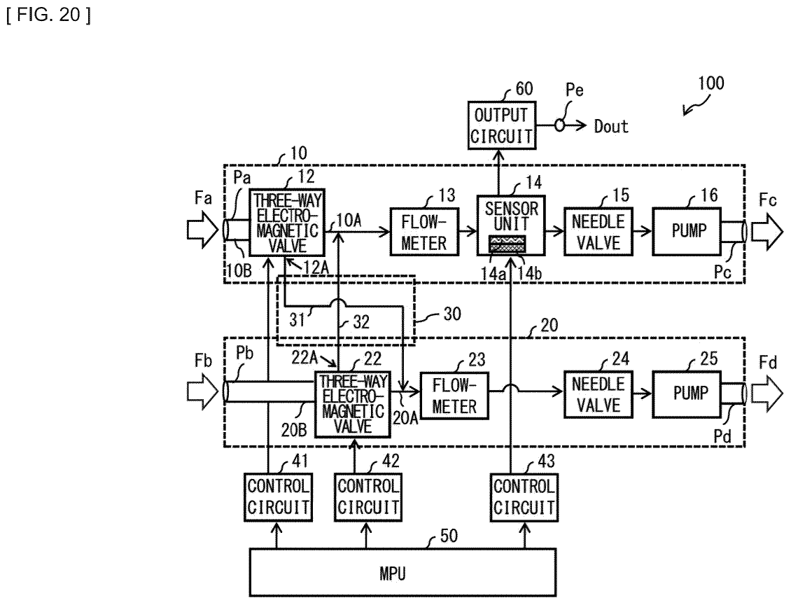

Modification Example H: An example in which a filter is omitted (FIG. 20)

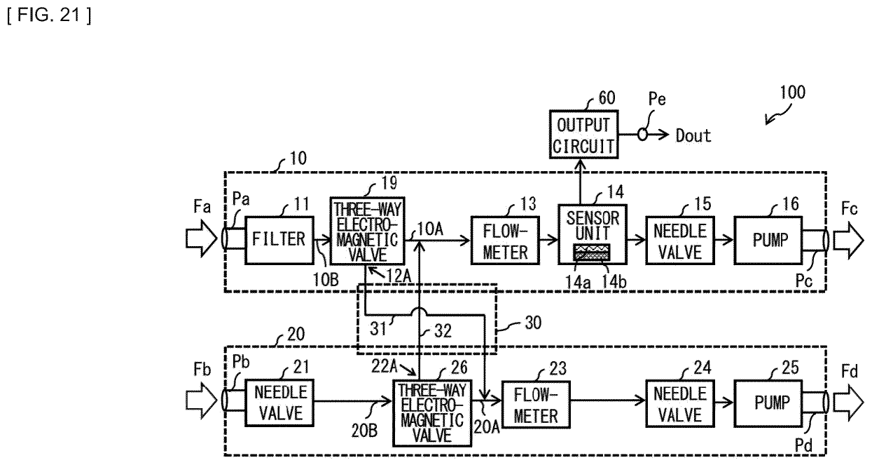

Modification Example I: An example in which a manual three-way valve is provided (FIG. 21)

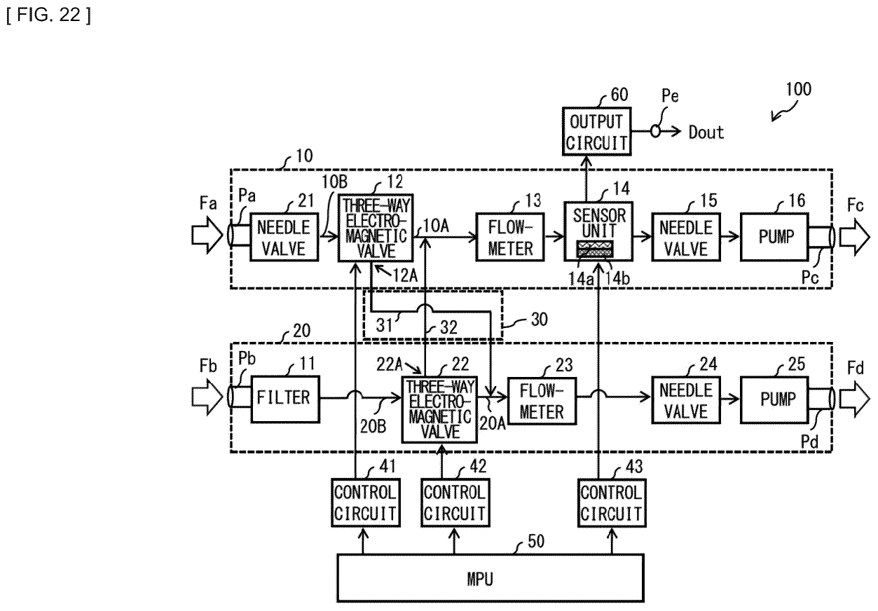

Modification Example J: An example in which some of components provided before a three-way electromagnetic valve are rearranged in a first flow channel and a second flow channel (FIG. 22 to FIG. 27)

### 3. APPLICATION EXAMPLE

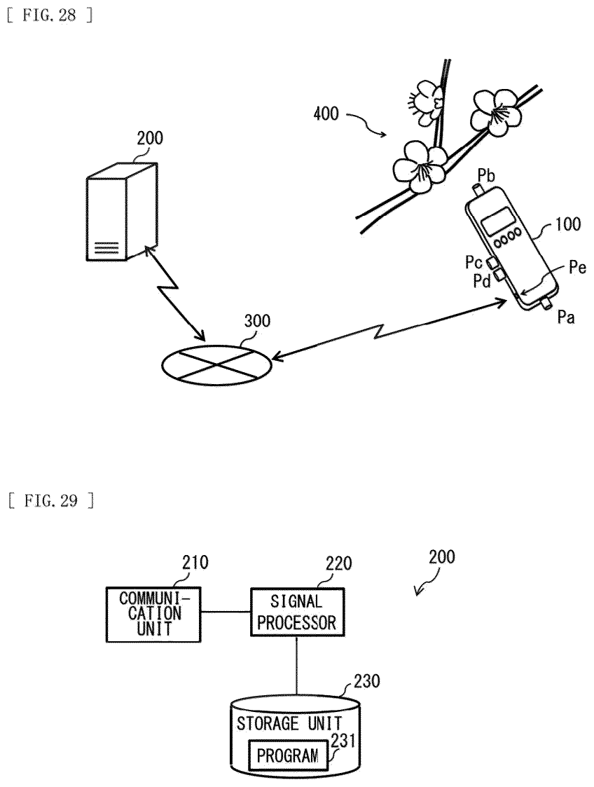

An example in which a server device processes data obtained by a gas evaluation device (FIG. 28 and FIG. 29)

### 4. MODIFICATION EXAMPLES

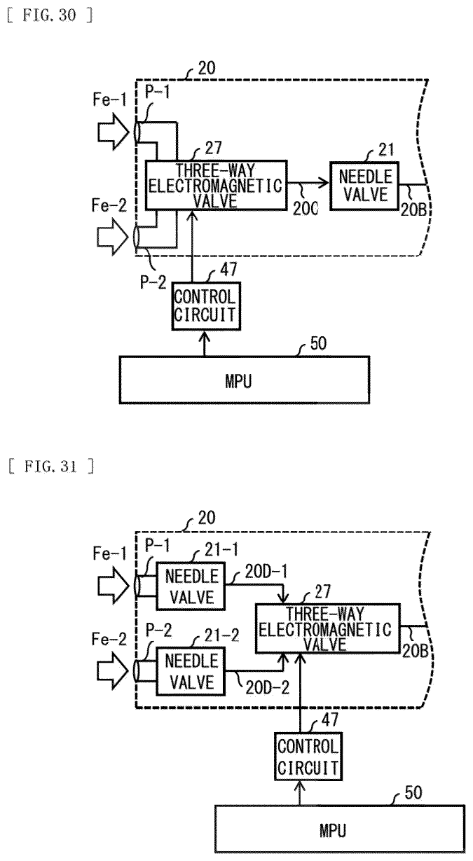

Modification examples of the gas measuring device in the embodiment and the modification examples of the embodiment described above (FIG. 30 to FIG. 37)

### 1. EMBODIMENT

### Configuration

FIG. 1 illustrates external appearance of a gas measuring device 100 according to an embodiment of the present disclosure. As illustrated in FIG. 1, for example, the gas measuring device 100 includes two gas flow inlets Pa and Pb that take in gas (outside air), two gas flow outlets Pc and Pd that discharge the gas (outside air) taken in at the two gas flow inlets Pa and Pb, and a signal output terminal Pe. The gas measuring device 100 further includes a housing 110, a display screen 120, and an operating unit 130. The housing 110 stores the two gas flow inlets Pa and Pb and flow channels (a first flow channel 10, a second flow channel 20, and a branched flow channel 30, to be described below), or the like, that are provided between and the two gas flow inlets Pa and Pb.

The gas flow inlet Pa and the gas flow inlet Pb are disposed at mutually different locations, and, for example, are disposed at two locations spaced apart by a predetermined distance in the gas measuring device 100. The gas flow outlets Pc and Pd are disposed, for example, at locations spaced apart by a predetermined distance from the gas flow inlets Pa and Pb. The display screen 120 is a display screen of a display. For example, contents, or the like, input to the operating unit 130 are displayed on the display screen 120. The operating unit 130 is an interface that accepts input from a user, and outputs contents input by the user to an MPU 50 to be described below.

A common gas flow inlet may be provided instead of the two gas flow inlets Pa and Pb. In addition, a common gas flow outlet may be provided instead of the two gas flow outlets Pc and Pd. The external appearance of the gas measuring device 100 is not limited to the external appearance illustrated in FIG. 1, and may be different appearance from the external appearance illustrated in FIG. 1.

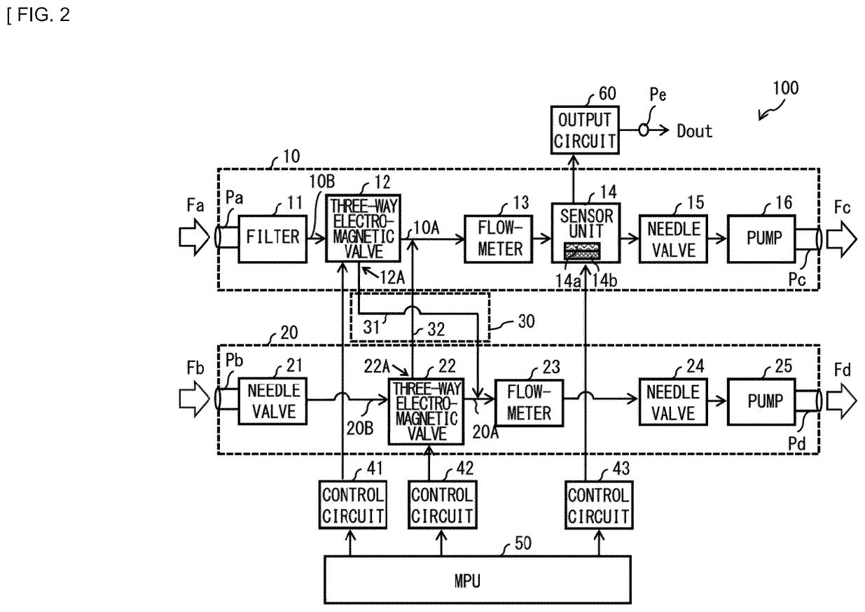

FIG. 2 illustrates an example of functional blocks of the gas measuring device 100. As illustrated in FIG. 2, for example, the gas measuring device 100 includes a first flow channel 10, a second flow channel 20, and a branched flow channel 30.

### First Flow Channel 10

The first flow channel 10 includes a three-way electromagnetic valve 12 with one input and two outputs. The three-way electromagnetic valve 12 has one inlet port, two outlet ports, and an electromagnetically driven switching valve for selecting either of the two outlet ports. In the three-way electromagnetic valve 12, the inlet port is coupled to a flow channel 10B, and one of the outlet ports is coupled to a flow channel 10A and another one of the outlet ports is coupled to a branched flow channel 31 to be described below. The flow channel 10B is coupled to the gas flow inlet Pa. Hereinafter, in the three-way electromagnetic valve 12, the outlet port coupled to the branched flow channel 31 is referred to as an outlet port 12A.

The first flow channel 10 further includes a filter 11 coupled to the flow channel 10B on an input side of the three-way electromagnetic valve 12, a flowmeter 13 coupled to the flow channel 10A on a first output side of the three-way electromagnetic valve 12, a sensor unit 14, a needle valve 15, and a pump 16. The filter 11 is provided between the gas flow inlet Pa and the three-way electromagnetic valve 12. The first flow channel 10 has the gas flow inlet Pa that directly takes in gas, and the gas flow outlet Pc that discharges the gas taken in at the gas flow inlet Pa to the outside. In FIG. 2, gas (outside air) flowing into the gas flow inlet Pa is represented by Fa and gas to be discharged from the gas flow outlet Pc is represented by Fc.

The filter 11 is a filter that purifies the gas (outside air) taken in at the gas flow inlet Pa and is an activated charcoal filter, for example. A base gas is obtained by purifying gas Fa (outside air) taken in at the gas flow inlet Pa with the filter 11. The base gas is air that does not contain volatile components that may react in the sensor unit 14 (or that contains only a negligeable amount of volatile components that may react in the sensor unit 14, as compared to an evaluation gas). The filter 11 is provided on the flow channel 10B on the input side of the three-way electromagnetic valve 12. The filter 11 is provided between the gas flow inlet Pa and the three-way electromagnetic valve 12. The three-way electromagnetic valve 12 has a mechanism configured to open and close the valve by electronic control, and the valve is opened or closed on the basis of control by a control circuit 41 to be described below.

The flowmeter 13 measures a flow rate of gas flowing through the first flow channel 10 (flow channel 10A). The flowmeter 13 outputs measurement data obtained by measurement to outside (an output circuit 60 to be described below). The flowmeter 13 is provided on the flow channel 10A on the first output side of the three-way valve 12.

The sensor unit 14 measures a target component in the gas flowing through the first flow channel 10 (flow channel 10A). The sensor unit 14 is provided in the first flow channel 10 (flow channel 10A). One sensor unit 14 or a plurality of the sensor units 14 may be provided in the first flow channel 10 (flow channel 10A). In a case in which the plurality of sensor units 14 is provided in the first flow channel 10 (flow channel 10A), it is possible to identify differences in volatile components contained in the gas flowing through the first flow channel 10 (flow channel 10A), for example, on the basis of a response pattern of each of the plurality of sensor units 14.

The sensor unit 14 includes, for example, a gas sensor 14a, a heater 14b that heats the gas sensor 14a, and a readout circuit 14c. The gas sensor 14a detects the target component in the gas flowing through the first flow channel 10 (flow channel 10A), thereby obtaining a detection result, and outputs the detection result to the readout circuit 14c. The readout circuit 14c outputs, to the output circuit 60, a detection signal generated on the basis of the detection result obtained from the gas sensor 14a.

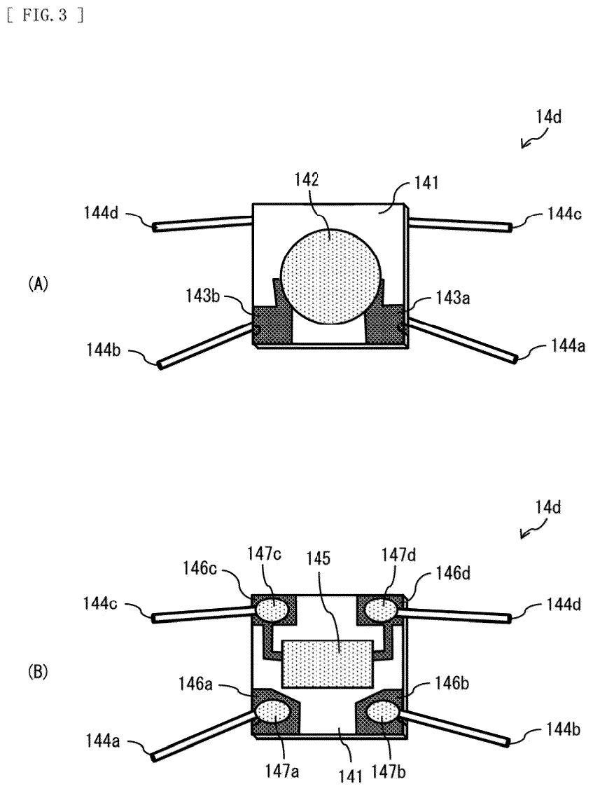

The sensor unit 14 may have a gas sensor 14d with a built-in heater, instead of the gas sensor 14a and the heater 14b. As illustrated in FIG. 3(A), for example, the gas sensor 14d has an alumina substrate 141, a gas detection layer 142, and electrodes 143a and 143b. The gas detection layer 142 and the electrodes 143a and 143b are disposed on one surface (top surface) of the alumina substrate 141. As illustrated in FIG. 3(B), the gas sensor 14d has lead wires 144a, 144b, 144c, and 144d, a heater layer 145, electrodes 146a, 146b, 146c, and 146d, and solders 147a, 147b, 147c, and 147d. The lead wires 144a, 144b, 144c, and 144d, the heater layer 145, the electrodes 146a, 146b, 146c, and 146d, and the solders 147a, 147b, 147c, and 147d are disposed on another surface (rear surface) of the alumina substrate 141.

The alumina substrate 141 is, for example, plate-shaped alumina with a side length of approximately 2 mm long and a thickness of approximately 0.3 mm. The gas detection layer 142 includes, for example, a metal oxide semiconductor. In a case in which the gas detection layer 142 includes tin oxide, for example, and the tin oxide is exposed to gas molecules of the target component at temperatures of several hundred degrees, the gas molecules of the target component capture electrons in the tin oxide and are adsorbed on a surface of the tin oxide, resulting in a change in resistance of the tin oxide. Therefore, it is possible to know presence or absence or concentration of the target component in the gas from a resistance value (sensor resistance value Rs) of the gas detection layer 142.

The electrodes 143a and 143b are terminals for applying a voltage to the gas detection layer 142. The electrode 146a is electrically coupled to the electrode 143a. The electrode 146b is electrically coupled to the electrode 143b. The heater layer 145 is a heating element that heats the gas detection layer 142 to a predetermined temperature via the alumina substrate 141. The heater layer 145 includes, for example, a ceramic heater or a platinum heater. The electrodes 146c and 146d are terminals for supplying an electric current to the heater layer 145. The lead wires 144a, 144b, 144c, and 144d are external terminals for coupling the gas sensor 14d and an external power source. The lead wire 144a is electrically coupled to the electrode 146a by the solder 147a. The lead wire 144b is electrically coupled to the electrode 146b by the solder 147b. The lead wire 144c is electrically coupled to the electrode 146c by the solder 147c. The lead wire 144d is electrically coupled to the electrode 146d by the solder 147a.

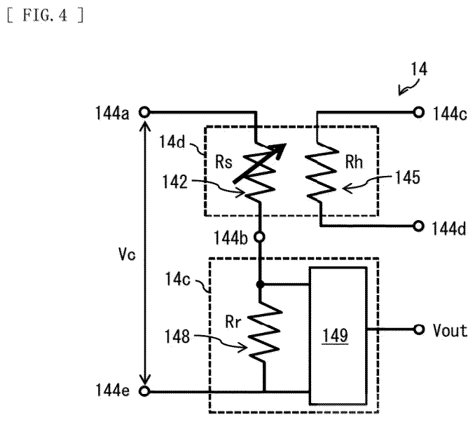

FIG. 4 illustrates a circuit configuration example of the sensor unit 14. As illustrated in FIG. 4, the sensor unit 14 includes the gas sensor 14d and the readout circuit 14c. The gas sensor 14d has the gas detection layer 142 and the heater layer 145. Here, a resistance value of the gas detection layer 142 is expressed as a sensor resistance value Rs. A resistance value of the heater layer 145 is expressed as a resistance value Rh. The readout circuit 14c has, for example, a reference resistor element 148 coupled in series to the gas detection layer 142 and a detection circuit 149 that detects a voltage Vout of the reference resistor element 148. The detection circuit 149 outputs the detected voltage Vout to the output circuit 60. The detection circuit 149 outputs data regarding the voltage Vout as a digital signal to the output circuit 60.

The needle valve 15 is a throttle valve for adjusting a flow rate of the gas flowing through the first flow channel 10 (flow channel 10A). In the needle valve 15, turning an adjusting knob to a closing direction decreases the flow rate and turning the adjusting knob to an opening direction increases the flow rate. The pump 16 is a mechanism for sucking up gas by action of pressure. The needle valve 15 and the pump 16 are provided in the flow channel 10A.

### Second Flow Channel 20

The second flow channel 20 includes a three-way electromagnetic valve 22 with one input and two outputs. The three-way electromagnetic valve 22 has one inlet port, two outlet ports, and an electromagnetically driven switching valve for selecting either of the two outlet ports. In the three-way electromagnetic valve 22, the inlet port is coupled to a flow channel 20B, and one of the outlet ports is coupled to a flow channel 20A and another one of the outlet ports is coupled to a branched flow channel 32 to be described below. The flow channel 20B is coupled to the gas flow inlet Pb. Hereinafter, the outlet port coupled to the branched flow channel 31 in the three-way electromagnetic valve 22 is referred to as an outlet port 22A.

The second flow channel 20 further includes a needle valve 21 coupled to the flow channel 20B on an input side of the three-way electromagnetic valve 22, a flowmeter 23 coupled to the flow channel 20A on a first output side of the three-way electromagnetic valve 22, a needle valve 24, and a pump 25. The needle valve 21 is provided between the gas flow inlet Pb and the three-way electromagnetic valve 22. The second flow channel 20 has the gas flow inlet Pb that directly takes in gas, and the gas flow outlet Pd that discharges the gas taken in at the gas flow inlet Pb to the outside. In FIG. 2, gas (outside air) flowing into the gas flow inlet Pb is represented by Fb and gas to be discharged from the gas flow outlet Pd is represented by Fd.

The needle valve 21 is a throttle valve for adjusting a flow rate of gas flowing through the second flow channel 20 (flow channel 20B). In the needle valve 21, turning an adjusting knob to a closing direction decreases the flow rate and turning the adjusting knob to an opening direction increases the flow rate. The needle valve 21 is provided in the flow channel 20B. The three-way electromagnetic valve 22 has a mechanism configured to open and close the valve by electronic control, and the valve is opened or closed on the basis of control by a control circuit 42 to be described below.

The flowmeter 23 measures a flow rate of gas flowing through the second flow channel 20 (flow channel 20A). The flowmeter 23 outputs measurement data obtained by the measurement to the outside (the output circuit 60 to be described below). The flowmeter 23 is provided in the flow channel 20A on the first output side of the three-way electromagnetic valve 22.

The needle valve 24 is a throttle valve for adjusting the gas flowing through the second flow channel (flow channel 20A). In the needle valve 24, turning an adjusting knob to a closing direction decreases the flow rate and turning the adjusting knob to an opening direction increases the flow rate. The pump 25 is a mechanism for sucking up gas by the action of pressure. The needle valve 24 and the pump 25 are provided in the flow channel 20A.

### Branched Flow Channel 30

As illustrated in FIG. 2, for example, the branched flow channel 30 has two branched flow channels 31 and 32. The branched flow channel 31 is coupled to the outlet port 12 of the three-way electromagnetic valve 12 and the flow channel 20A on the first output side of the three-way electromagnetic valve 22. The branched flow channel 31 corresponds to the flow channel on the second output side of the three-way electromagnetic valve 12. The branched flow channel 32 is coupled to the outlet port 22A of the three-way electromagnetic valve 22 and the flow channel 10A on a first output side of the three-way electromagnetic valve 12. The branched flow channel 32 corresponds to the flow channel on a second output side of the three-way electromagnetic valve 22.

As illustrated in FIG. 2, for example, the gas measuring device 100 further includes control circuits (control circuits 41 to 43), an MPU (micro-processing unit) 50, and the output circuit 60. The output circuit 60 corresponds to a specific example of a “signal processor that processes a detection signal” according to an embodiment of the present disclosure.

The control circuit 41 controls opening and closing of the three-way electromagnetic valve 12 in accordance with the control of the MPU 50. The control circuit 42 controls opening and closing of the three-way electromagnetic valve 22 in accordance with the control of the MPU 50. The control circuit 43 controls the sensor unit 14 in accordance with the control of the MPU 50. The control circuit 43 is allowed to adjust temperature of the gas sensor 14a or 14d by controlling the heater 14b or the heater layer 145 in accordance with the control of the MPU 50. The MPU 50 controls the control circuits 41 to 43. The MPU 50 controls the control circuits 41 to 43 in accordance with control from an external device.

The output circuit 60 derives the sensor resistance value Rs on the basis of the detection signal obtained from the sensor unit 14. The output circuit 60 includes, for example, an IC (integrated circuit). The output circuit 60 derives the sensor resistance value Rs using the following expression. The output circuit 60 outputs data regarding the derived sensor resistance value Rs as output data Dout to the outside.

$$( Vc - Vout ) / Vout ) \times Rr$$

Vc: A voltage to be applied to resistance including the gas detection layer 142 and the reference resistor element 148
Vout: A voltage of the reference resistor element 148 (a voltage value detected in the detection circuit 149)
Rr: A resistance value of the reference resistor element 148

The output circuit 60 outputs, for example, measurement data obtained by the flowmeters 13 and 23 as output data Dout to the external device. The output circuit 60 outputs, for example, the output data Dout via a signal output terminal Pe to the external device.

### Straight Flow Channel

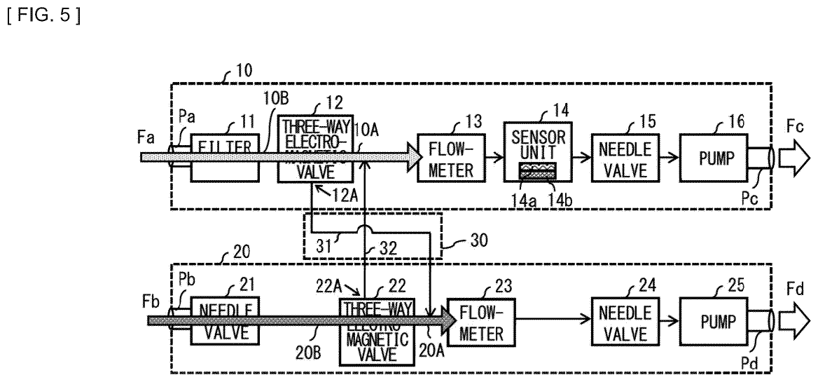

FIG. 5 illustrates a measurement example of base gas in the gas measuring device 100. The control circuit 41 outputs a control signal to the three-way electromagnetic valve 12, thereby causing the flow channel 10B on the input side of the three-way electromagnetic valve 12 to communicate with the flow channel 10A on the first output side of the three-way electromagnetic valve 12 in the three-way electromagnetic valve 12. Furthermore, the control circuit 42 outputs a control signal to the three-way electromagnetic valve 22, thereby causing the flow channel 20B on the first output side of the three-way electromagnetic valve 22 to communicate with the flow channel 20A on the first output side of the three-way electromagnetic valve 22 in the three-way electromagnetic valve 22.

As a result, by the action of the pump 16, the gas Fa that has flowed into the gas flow inlet Pa flows into the flowmeter 13, the sensor unit 14, the needle valve 15, and the pump 16 via the filter 11 and the three-way electromagnetic valve 12. At this time, the gas Fa flows through the flow channel, referred to as a “straight flow channel”, in the three-way electromagnetic valve 12. The gas Fa is purified by the filter 1, and base gas is thus obtained.

In contrast, by the action of the pump 25, the gas Fb that has flowed into the gas flow inlet Pb flows into the flowmeter 23, the needle valve 24, and the pump 25 via the needle valve 21 and the three-way electromagnetic valve 22. At this time, the gas Fb flows through the flow channel, referred to as a “straight flow channel”, in the three-way electromagnetic valve 22. A flow rate of the gas Fb is adjusted by the needle valve 21. The needle valve 21 is adjusted so that the flow rate of the gas Fb approaches the flow rate of the base gas. By the flow rate being adjusted by the needle valve 21, an evaluation gas is obtained. Similarly to the gas Fb, the evaluation gas is air that may contain a target component (volatile molecules to be measured).

### Branched Flow Channel

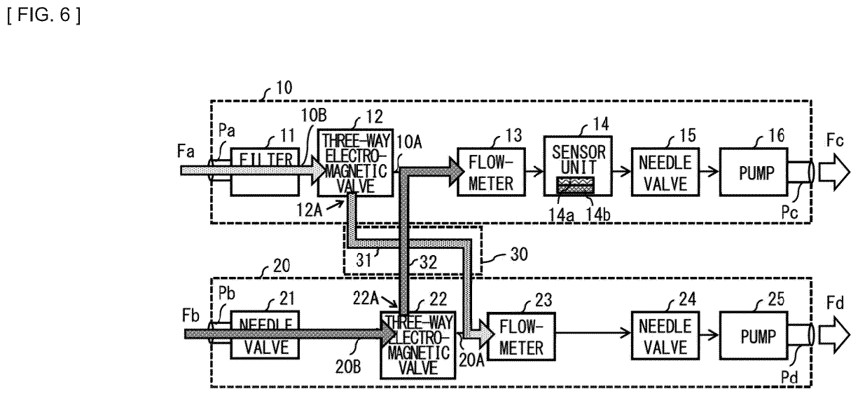

FIG. 6 illustrates an example of measurement of the evaluation gas in the gas measuring device 100. The control circuit 41 outputs a control signal to the three-way electromagnetic valve 12, thereby causing the flow channel 10B on the input side of the three-way electromagnetic valve 12 to communicate with the flow channel (branched flow channel 31) on the second output side of the three-way electromagnetic valve 12, in the three-way electromagnetic valve 12. Furthermore, the control circuit 42 outputs a control signal to the three-way electromagnetic valve 22, thereby causing the flow channel 20B on the input side of the three-way electromagnetic valve 22 to communicate with the flow channel (branched flow channel 32) on the second output side of the three-way electromagnetic valve 22, in the three-way electromagnetic valve 22.

As a result, by the action of the pump 25, the gas Fa that has flowed into the gas flow inlet Pa flows into the second flow channel 20 (specifically, the flowmeter 23, the needle valve 24, and the pump 25) via the three-way electromagnetic valve 12 and the branched flow channel 31. At this time, the gas Fa flows through the flow channel, referred to as a “branched flow channel”, in the three-way electromagnetic valve 12.

In contrast, by the action of the pump 16, the gas Fb that has flowed into the three-way electromagnetic valve 12 flows into the first flow channel 10 (specifically, the flowmeter 13, the sensor unit 14, the needle valve 15, and the pump 16) via the three-way electromagnetic valve 22 and the branched flow channel 32. At this time, the gas Fb flows through the flow channel, referred to as a “branched flow channel”, in the three-way electromagnetic valve 22.

### Gas Measurement Procedure

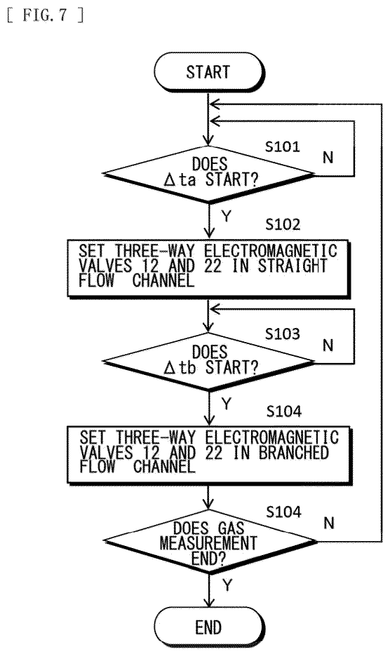

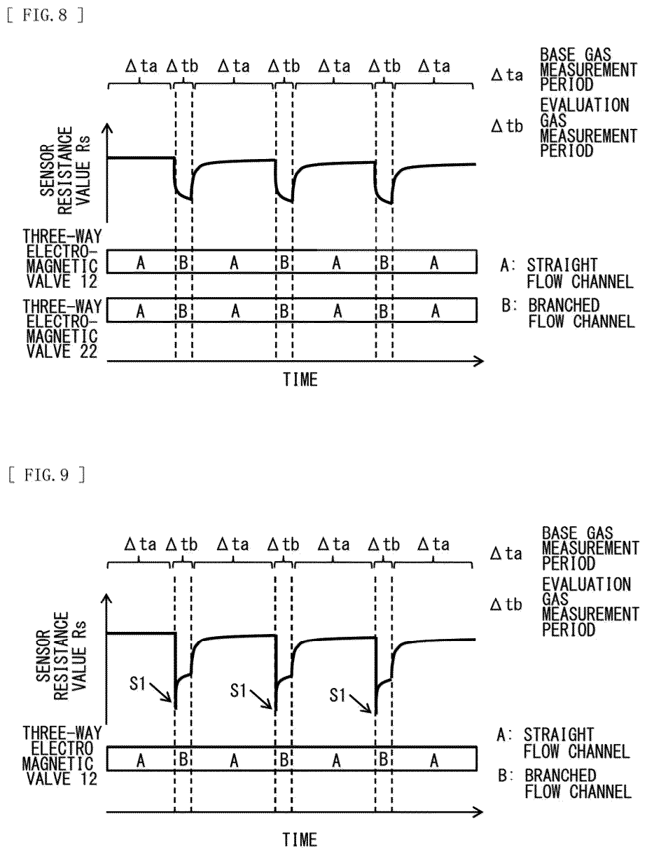

In the following, a description is given of a gas measurement procedure in the gas measuring device 100. FIG. 7 illustrates an example of the gas measurement procedure in the gas measuring device 100. FIG. 8 illustrates an example of the sensor resistance value Rs and an example of states of two three-way electromagnetic valves.

The control circuits 41 and 42 judge whether a base gas measurement period Δta is to be started or not (step S101). In a case in which the control circuits 41 and 42 obtain a start signal for the base gas measurement period Δta from the MPU 50, for example, the control circuits 41 and 42 determine that the base gas measurement period Δta is to be started (step S101: Y), and output, to the three-way electromagnetic valves 12 and 22, a control signal for setting the three-way electromagnetic valves 12 and 22 in straight flow channels. In a case in which the control signal for setting the three-way electromagnetic valves 12 and 22 in the straight flow channels is input from the control circuits 41 and 42, the three-way electromagnetic valves 12 and 22 are set in the straight flow channels (step S102). That is, in the three-way electromagnetic valve 12, the control circuit 41 causes the flow channel 10B on the input side of the three-way electromagnetic valve 12 to communicate with the flow channel 10A on the first output side of the three-way electromagnetic valve 12. Furthermore, in the three-way electromagnetic valve 22, the control circuit 42 causes the flow channel 20B on the input side of the three-way electromagnetic valve 22 to communicate with the flow channel 20A on the first output side of the three-way electromagnetic valve 22.

As a result, by the action of the pump 16, the gas Fa that has flowed into the gas flow inlet Pa is drawn into the flowmeter 13, the sensor unit 14, the needle valve 15, and the pump 16 via the filter 11 and the three-way electromagnetic valve 12. At this time, the outside air drawn by the action of the pump 16 being purified by the filter 11, the base gas is obtained. The base gas flows into the sensor unit 14. The sensor unit 14 detects the base gas that has flowed into the sensor unit 14 and outputs a detection signal thereby obtained to the output circuit 60.

In contrast, by the action of the pump 25, the gas Fb that has flowed into the gas flow inlet Pb is drawn into the flowmeter 23, the needle valve 24, and the pump 25 via the needle valve 21 and the three-way electromagnetic valve 22. At this time, a flow rate of the outside air drawn by the action of the pump 25 being regulated by the needle valve 21, the evaluation gas with the flow rate adjusted is obtained.

The control circuits 41 and 42 judge whether a base gas measurement period Δtb is to be started or not (step S103). In a case in which the control circuits 41 and 42 obtain a start signal for the base gas measurement period Δtb from the MPU 50, for example, the control circuits 41 and 42 determine that an evaluation gas measurement period Δtb is to be started (step S103: Y), and output, to the three-way electromagnetic valves 12 and 22, a control signal for setting the three-way electromagnetic valves 12 and 22 in branched flow channels. In a case in which the control signal for setting the three-way electromagnetic valves 12 and 22 in the branched flow channels is input from the control circuits 41 and 42, the three-way electromagnetic valves 12 and 22 are set in the branched flow channels (step S104). That is, in the three-way electromagnetic valve 12, the control circuit 41 causes the flow channel 10B on the input side of the three-way electromagnetic valve 12 to communicate with the flow channel (branched flow channel 31) on the second output side of the three-way electromagnetic valve 12. Furthermore, in the three-way electromagnetic valve 22, the control circuit 42 causes the flow channel 20B on the input side of the three-way electromagnetic valve 22 to communicate with the flow channel (branched flow channel 32) on the second output side of the three-way electromagnetic valve 22.

As a result, by the actin of the pump 25, the base gas that has flowed into the three-way electromagnetic valve 12 is drawn into the second flow channel 20 (specifically, the flowmeter 23, the needle valve 24, and the pump 25) via the branched flow channel 31. At this time, the outside air drawn by the action of the pump 25 being purified by the filter 11, the base gas is obtained.

In contrast, by the action of the pump 16, the evaluation gas that has flowed into the three-way electromagnetic valve 22 flows into the first flow channel 10 (specifically, the flowmeter 13, the sensor unit 14, the needle valve 15, and the pump 16) via the branched flow channel 32. The evaluation gas flows into the sensor unit 14. The sensor unit 14 detects the evaluation gas that has flowed into the sensor unit 14, and outputs a detection signal thereby obtained to the output circuit 60.

The control circuits 41 and 42 alternately perform control for base gas measurement and control for evaluation gas measurement, in accordance with the control of the MPU 50. That is, the control circuits 41 and 42 alternately perform the control for base gas measurement and the control for evaluation gas measurement, by opening and closing the three-way electromagnetic valve 12 and the three-way electromagnetic valve 22. At this time, as illustrated in FIG. 8, for example, the sensor resistance value Rs decreases every time the gas sensor 14a (or the gas sensor 14d) is exposed to the evaluation gas and returns to a predetermined value every time the gas sensor 14a (or the gas sensor 14d) is exposed to the base gas.

FIG. 9 illustrates an example of the sensor resistance value Rs obtained by gas measurement in a gas measuring device according to a comparative example, and an example of a state of one three-way electromagnetic valve. The gas measuring device according to the comparative example includes a three-way electromagnetic valve with two inputs and one output. In this three-way electromagnetic valve, a flow channel for taking in a base gas is coupled to a flow channel on a first input side of the three-way electromagnetic valve, and a flow channel for taking in an evaluation gas is coupled to a flow channel on a second side of the three-way electromagnetic valve.

In this three-way electromagnetic valve, when the flow channel on the first side of the three-way electromagnetic valve communicates with the flow channel on an output side of the three-way electromagnetic valve, the base gas flows from the flow channel on the first input side to the flow channel on the output side. At this time, the flow channel in the three-way electromagnetic valve 12 is referred to as a “base gas flow channel” and the base gas flows through the base gas flow channel. At this time, the base gas flows through the flow channel, referred to as a “base gas flow channel”, in the three-way electromagnetic valve 12. In addition, in this three-way electromagnetic valve, when the flow channel on the second input side of the three-way electromagnetic valve communicates with the flow channel on the output side of the three-way electromagnetic valve, the evaluation gas flows from the flow channel on the second input side to the flow channel on the output side. At this time, the evaluation gas flows through the flow channel, referred to as an “evaluation gas flow channel”, in the three-way electromagnetic valve.

In the gas measuring device according to the comparative example, when the base gas measurement and the evaluation gas measurement are performed alternately, as illustrated in FIG. 9, for example, the sensor resistance value Rs decreases every time a gas sensor is exposed to the evaluation gas and returns to a predetermined value every time the gas sensor is exposed to the base gas. At this time, spike-shaped noise S1 is generated in the sensor resistance value Rs, when the base gas is switched to the evaluation gas. Such noise S1 prevents a target component in a gas from being measured with good accuracy. In contrast, in the gas measuring device 100 according to this embodiment, generation of such spike-shaped noise is suppressed.

### Effects

In the following, a description is given of effects of the gas measuring device 100.

In this embodiment, the first flow channel 10 including the three-way electromagnetic valve 12 and the second flow channel 20 including the three-way electromagnetic valve 22 are provided. Furthermore, the branched flow channel 31 coupled to the second output (outlet port 12A) of the three-way electromagnetic valve 12 and the branched flow channel 31 coupled to the flow channel 20A on the first output side of the three-way electromagnetic valve 22 as well as the branched flow channel 32 coupled to the second output (outlet port 22A) of the three-way electromagnetic valve 22 and the flow channel 10A on the first output side of the three-way electromagnetic valve 12 are provided. Consequently, by opening and closing the three-way electromagnetic valves 12 and 22, it is possible for the base gas flowing through the three-way electromagnetic valve 12 and the evaluation gas flowing through the three-way electromagnetic valve 12 to alternately flow into the sensor unit 14 without stopping the flow of both gases. As a result, it is possible to suppress generation of noise when switching between two types of gases. Therefore, measuring a target component in gas with good accuracy is possible. For example, it is possible to detect the target component in the evaluation gas on the basis of sensitivity (the sensor resistance value Rs when detecting the base gas/the sensor resistance value Rs when detecting the evaluation gas) or a change (such as a time constant) in the sensor resistance value Rs when switching from the evaluation gas to the base gas).

In this embodiment, in the first flow channel 10, no mechanism that mixes predetermined gas with the outside air taken in from the gas flow inlet Pa is provided between the gas flow inlet Pa and the three-way electromagnetic valve 12. Furthermore, in the second flow channel 20, no mechanism that mixes the predetermined gas with the outside air taken in from the gas flow inlet Pb is provided between the gas flow inlet Pb and the three-way electromagnetic valve 22. Examples of the above-described device include a mechanism that supplies a fixed flow of gas from a gas cylinder or a pipeline or a device that vaporizes an organic solvent such as permeator to be mixed with gas at a certain concentration. This allows the gas measuring device 100 to be made smaller in size than a case in which these mechanisms are provided.

In this embodiment, in the first flow channel 10, the filter 11 for purifying the outside air taken in from the gas flow inlet Pa is provided between the gas flow inlet Pa and the three-way electromagnetic valve 12, and the needle valve 21 that regulates the flow rate of the outside air taken in from the gas flow inlet Pb is provided between the gas flow inlet Pb and the three-way electromagnetic valve 22. This makes it possible to bring the flow rate of the evaluation gas closer to the flow rate of the base gas. As a result, when the types of gas flowing to the sensor unit 14 is switched by opening and closing the three-way electromagnetic valve 12 and 22, it is possible to keep small a change in the gas flowing through the sensor unit 14, so that it is possible to suppress the generation of noise when switching between the two types of gases. Therefore, it is possible to measure the target component in the gas with good accuracy.

In this embodiment, the control circuits 41 and 42 are provided that make it possible to control opening and closing the three-way electromagnetic valves 12 and 22. This allows switching timing to be performed with good accuracy as compared to a case in which flow channels are switched manually. As a result, when the type of gas flowing to the sensor unit 14 is switched by opening and closing the three-way electromagnetic valves 12 and 22, it is possible to keep small the change in the flow rate of the gas flowing through the sensor unit 14, so that it is possible to suppress the generation of noise when switching between the two types of gases. Therefore, it is possible to measure the target component in the gas with good accuracy.

### 2. MODIFICATION EXAMPLES

In the following, a description is given of modification examples of the gas measuring device 100 according to the above-described embodiment.

### Modification Example A

In the embodiment described above, it may be possible for the control circuit 43 to exert control for refreshing the gas sensor 14a over the heater 14b. In the embodiment described above, it may also be possible for the control circuit 43to exert control for refreshing the gas sensor 14d over the heater layer 145. This makes it possible to refresh the gas sensor 14a (or the gas sensor 14d) by the heater 14b during the base gas measurement period Δta, for example. Here, in a case in which the gas sensor 14a (or the gas sensor 14d) includes, for example, tin oxide, refreshing of the gas sensor 14a (or the gas sensor 14d) refers to desorbing gas molecules adsorbed on a surface of tin oxide and adsorbing oxygen onto the surface of tin oxide. Examples of methods of desorbing the gas molecules adsorbed on the surface of tin oxide include making temperature of the surface of tin oxide higher than normal temperature (temperature necessary for measurement). Refreshing the gas sensor 14a (or the gas sensor 14d) makes it possible to reduce drift of the sensor resistance value Rs when the gas sensor 14a (or the gas sensor 14d) is saturated.

FIG. 10 illustrates an example of the sensor resistance value Rs when refreshing of the gas sensor 14a (or the gas sensor 14d) is performed in the gas measuring device 100. The MPU 50 exerts control over the control circuit 43 so that the refreshing of the gas sensor 14a (or the gas sensor 14d) is controlled by the control circuit 43 during the base gas measurement period Δta. For example, when a start signal of a refresh period Δtc is obtained from the MPA 50, the control circuit 43 determines that the refresh period Δtc is to start, and outputs a control signal (a control signal c1) to the heater 14b so that the temperature becomes higher than the normal temperature (the temperature necessary for measurement). For example, when an end signal of the refresh period Δtc is obtained from the MPA 50, the control circuit 43 determines that the refresh period Δtc is to end, and outputs a control signal (a control signal c2) to the heater 14b so that the temperature becomes the normal temperature (the temperature necessary for measurement). During a measurement period excluding the refresh period Δtc, the control circuit 43 outputs the control signal (the control signal c2) to the heater 14b so that the temperature becomes the normal temperature (the temperature necessary for measurement).

The heater 14b is heated to temperature based on a control signal from the control circuit 43. In a case in which the control signal c1 is input from the control circuit 43, the heater 14b is heated to temperature higher than when the control signal c2 is input. In a case in which the control signal c2 is input from the control circuit 43, the heater 14b is heated to the normal temperature (the temperature necessary for measurement).

FIG. 11 illustrates an example of the sensor resistance value Rs when refreshing is performed at two types of temperatures. When refresh temperature Tr (temperature of the heater 14b) is Ta (350 degrees, for example), it is seen that the sensor resistance value Rs becomes a constant value until a next evaluation gas measurement period Δtb begins. In contrast, when the refresh temperature Tr (the temperature of the heater 14b) is Tb (500 degrees, for example), it is seen that the sensor resistance value Rs does not become a constant value until the next evaluation gas measurement period Δtb begins, and that the sensor resistance value Rs is still on a downward trend. For measuring the target component in the evaluation gas with good accuracy, it is necessary that the sensor resistance value Rs be a constant value before the evaluation gas measurement period Δtb starts. Therefore, for measuring the target component in the evaluation gas with good accuracy, it is preferable that the refresh temperature Tr (the temperature of the heater 14b) be Ta rather than Tb. It is also preferable that the MPU 50 output a start signal and an end signal of the refresh period Δtc to the control circuit 43 at a timing that allows for a sufficient period for the sensor resistance value Rs to become a constant value.

In this modification example, refreshing is performed on the gas sensor 14a (or the as sensor 14d) during the base gas measurement period Δta. This allows the target component in the gas to be measured with good accuracy.

### Modification Example B

In the embodiment described above and its modification examples, as illustrated in FIG. 12, for example, the flowmeter 13 may be provided at the rear of the sensor unit 14. In such a case, control similar to the embodiment described above is possible by learning, in advance, a difference in the flow rates in front or at the rear of the sensor unit 14 and adding the above difference in the flow rates to the flow rate data obtained by the flowmeter 13. Therefore, even in this modification example, it is possible to measure the target component in the gas with good accuracy, similarly to the embodiment described above.

It is to be noted that in this modification example, a mass flow may be provided instead of the flowmeter 13 and the needle valve 15. Even in such a case, similarly to the embodiment described above, it is possible to measure the target component in the gas with good accuracy.

### Modification Example C

In the embodiment described above and its modification examples, as illustrated in FIG. 12, for example, the flowmeter 13 may be provided at the rear of the sensor unit 14. Even in such a case, similarly to the embodiment described above, it is possible to measure the target component in the gas with good accuracy.

It is to be noted that in this modification example, a mass flow may be provided instead of the flowmeter 13 and the needle valve 15. Even in such a case, similarly to the embodiment described above, it is possible to measure the target component in the gas with good accuracy.

### Modification Example D

In the embodiment described above and its modification examples, as illustrated in FIG. 12, for example, the pump 16 may be provided between the gas flow inlet Pa and the filter 11, and the pump 25 may be provided between the gas flow inlet Pb and the three-way electromagnetic valve 22. At this time, as illustrated in FIG. 14, for example, the needle valve 15 may be provided between the pump 16 and the filter 11.

### Straight Flow Channel

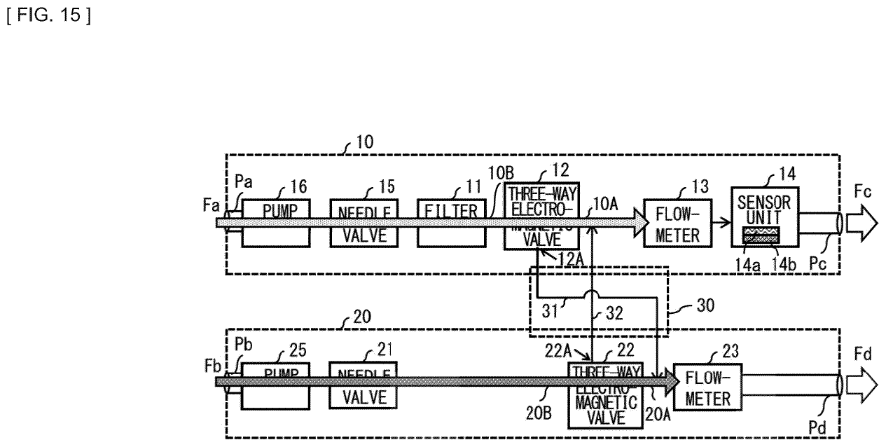

FIG. 15 illustrates an example of measurement of the base gas in the gas measuring device 100. In the base gas measurement period Δta, by outputting a control signal to the three-way electromagnetic valve 12, the control circuit 41 causes the flow channel 10B on the input side of the three-way electromagnetic valve 12 to communicate with the flow channel 10A on the first output side of the three-way electromagnetic valve 12, in the three-way electromagnetic valve 12. Furthermore, by outputting a control signal to the three-way electromagnetic valve 22, the control circuit 42 causes the flow channel 20B on the input side of the three-way electromagnetic valve 22 to communicate with the flow channel 20A on the first output side of the three-way electromagnetic valve 22.

As a result, the gas Fa drawn from the gas flow inlet Pa by the action of the pump 16 flows into the flowmeter 13 and the sensor unit 14 via the needle valve 15, the filter 11, and the three-way electromagnetic valve 12. The gas Fa is purified by the filter 11 and the base gas is thus obtained. In contrast, the gas Fb drawn from the gas flow inlet Pb by the action of the pump 25 flows into the flowmeter 23 via the needle valve 21 and the three-way electromagnetic valve 22. The flow rate of the gas Fb is adjusted by the needle valve 21. The needle valve 21 is adjusted so that the flow rate of the gas Fb approaches the flow rate of the base gas. The flow rate being adjusted by the needle valve 21, the evaluation gas is obtained.

### Branched Flow Channel

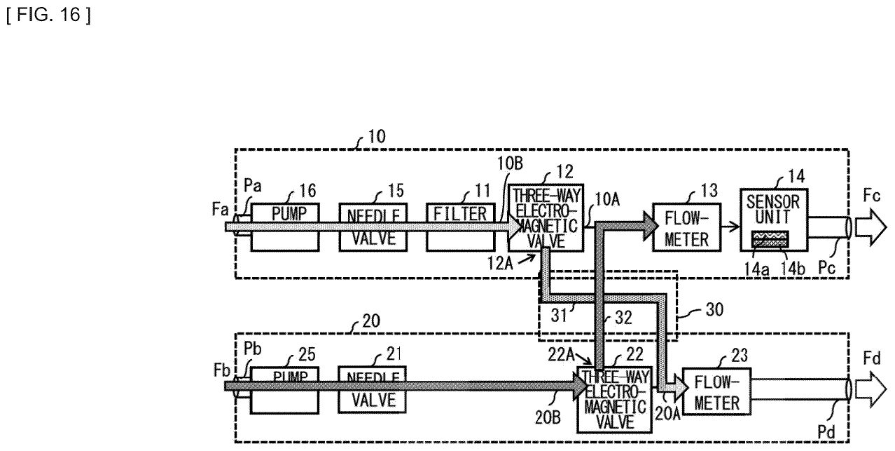

FIG. 16 illustrates an example of measurement of the evaluation gas in the gas measuring device 100. In the evaluation gas measurement period Δtb, by outputting a control signal to the three-way electromagnetic valve 12, the control circuit 41 causes the flow channel 10B on the input side of the three-way electromagnetic valve 12 to communicate with the flow channel (the branched flow channel 31) on the second output side of the three-way electromagnetic valve 12, in the three-way electromagnetic valve 12. Furthermore, by outputting a control signal to the three-way electromagnetic valve 22, the control circuit 42 causes the flow channel 20B on the input side of the three-way electromagnetic valve 22 to communicate with the flow channel (the branched flow channel 32) on the second output side of the three-way electromagnetic valve 22.

As a result, the gas Fb drawn from the gas flow inlet Pb by the action of the pump 25 flows into the first flow channel 10 (specifically, the flowmeter 13 and the sensor unit 14) via the needle valve 21, the three-way electromagnetic valve 22, and the branched flow channel 32. In contrast, the gas Fa drawn from the gas flow inlet Pa by the action of the pump 16 flows into the second flow channel 20 (specifically, the flowmeter 23) via the needle valve 21, the filter 11, the three-way electromagnetic valve 12, and the branched flow channel 31.

### Gas Measurement Procedure

In the following, a description is given of the gas measurement procedure in the gas measuring device 100 according to this modification example.

The control circuits 41 and 42 judge whether the base gas measurement period Δta is to be started or not. In a case in which the control circuits 41 and 42 obtain the start signal for the base gas measurement period Δta from the MPU 50, for example, the control circuits 41 and 42 determine that the base gas measurement period Δta is to be started, and output, to the three-way electromagnetic valves 12 and 22, the control signal for setting the three-way electromagnetic valves 12 and 22 in the straight flow channels. In a case in which the control signal for setting the three-way electromagnetic valves 12 and 22 in the straight flow channels is input from the control circuits 41 and 42, the three-way electromagnetic valves 12 and 22 are set in the straight flow channels. That is, in the three-way electromagnetic valve 12, the control circuit 41 causes the flow channel 10B on the input side of the three-way electromagnetic valve 12 to communicate with the flow channel 10A on the first output side of the three-way electromagnetic valve 12. Furthermore, in the three-way electromagnetic valve 22, the control circuit 42 causes the flow channel 20B on the input side of the three-way electromagnetic valve 22 to communicate with the flow channel 20A on the first output side of the three-way electromagnetic valve 22.

As a result, the gas Fa drawn from the gas flow inlet Pa by the action of the pump 16 flows into the flowmeter 13 and the sensor unit 14 via the needle valve 15, the filter 11, and the three-way electromagnetic valve 12. At this time, the outside air drawn by the action of the pump 16 being purified by the filter 11, the base gas is obtained. The base gas flows into the sensor unit 14. The sensor unit 14 detects the base gas that has flowed into the sensor unit 14 and outputs a detection signal thereby obtained to the output circuit 60.

In contrast, the gas Fb drawn from the gas flow inlet Pb by the action of the pump 25 flows into the flowmeter 23 via the needle valve 21 and the three-way electromagnetic valve 22. At this time, the flow rate of the outside air drawn by the action of the pump 25 being regulated by the needle valve 21, the evaluation gas with the flow rate adjusted is obtained.

The control circuits 41 and 42 judge whether the base gas measurement period Δtb is to be started or not. In a case in which the control circuits 41 and 42 obtain the start signal for the base gas measurement period Δtb from the MPU 50, for example, the control circuits 41 and 42 determine that the evaluation gas measurement period Δtb is to be started, and output, to the three-way electromagnetic valves 12 and 22, the control signal for setting the three-way electromagnetic valves 12 and 22 in the branched flow channels. In a case in which the control signal for setting the three-way electromagnetic valves 12 and 22 in the branched flow channels is input from the control circuits 41 and 42, the three-way electromagnetic valves 12 and 22 are set in the branched flow channels (step S104). That is, in the three-way electromagnetic valve 12, the control circuit 41 causes the flow channel 10B on the input side of the three-way electromagnetic valve 12 to communicate with the flow channel (branched flow channel 31) on the second output side of the three-way electromagnetic valve 12. Furthermore, in the three-way electromagnetic valve 22, the control circuit 42 causes the flow channel 20B on the input side of the three-way electromagnetic valve 22 to communicate with the flow channel (branched flow channel 32) on the second output side of the three-way electromagnetic valve 22.

As a result, the gas Fa drawn from the gas flow inlet Pa by the action of the pump 16 flows into the second flow channel 20 (specifically, the flowmeter 23) via the branched flow channel 31. At this time, the outside air drawn by the action of the pump 16 being purified by the filter 11, the base gas is obtained.

In contrast, the gas Fb drawn from the gas flow inlet Pb by the pump 25 flows into the first flow channel 10 (specifically, the flowmeter 13 and the sensor unit 14) via the branched flow channel 32. The evaluation gas flows into the sensor unit 14. The sensor unit 14 detects the evaluation gas that has flowed into the sensor unit 14, and outputs a detection signal thereby obtained to the output circuit 60.

The control circuits 41 and 42 alternately perform the control for base gas measurement and the control for evaluation gas measurement, in accordance with the control of the MPU 50. That is, the control circuits 41 and 42 alternately perform the control for base gas measurement and the control for evaluation gas measurement, by opening and closing the three-way electromagnetic valve 12 and the three-way electromagnetic valve 22. At this time, as illustrated in FIG. 8, for example, the sensor resistance value Rs decreases every time the gas sensor 14a (or the gas sensor 14d) is exposed to the evaluation gas and returns to a predetermined value every time the gas sensor 14a (or the gas sensor 14d) is exposed to the base gas.

In this modification example, the pump 16 is provided between the gas flow inlet Pa and the filter 11, and the pump 25 is provided between the gas flow inlet Pb and the three-way electromagnetic valve 22. Even in such a case, it is possible to measure the target component in the gas with good accuracy.

### Modification Example E

In the embodiment described above and its modification examples, as illustrated in FIG. 17, for example, the gas measuring device 100 may further include a control circuit 44 that controls the needle valve 15, a control circuit 45 that controls the needle valve 21, and a control circuit 46 that controls the needle valve 24. At this time, the MPU 50 is allowed to output control signals for setting adjustment amounts of the adjusting knobs of the needle valves 15, 21, and 24 to the control circuits 44, 45, and 46, on the basis of the flow rate data obtained by the flowmeters 13 and 23. The control circuit 44 controls the adjustment amount of the adjusting knob of the needle valve 15 in accordance with the control of the MPU 50. The control circuit 45 controls the adjustment amount of the adjusting knob of the needle valve 21 in accordance with the control of the MPU 50. The control circuit 46 controls the adjustment amount of the adjusting knob of the needle valve 24 in accordance with the control of the MPU 50.

In this modification example, the adjustment amounts of the adjusting knobs of the needle valves 15, 21, and 24 are controlled on the basis of the measurement data obtained by the flowmeters 13 and 23. This makes it possible to bring the flow rate of the evaluation gas closer to the flow rate of the base gas, thus allowing for suppression of noise generation when switching between the two types of gases. Therefore, it is possible to measure the target component in the gas with good accuracy.

### Modification Example F

In the embodiment described above and its modification examples, as illustrated in FIG. 18, for example, the gas measuring device 100 may further include a humidification mechanism 17 and a hygrometer 18 in the first flow channel 10. The humidification mechanism 17 is, for example, a bubbling device, a vaporization device, or a humidifier, or the like. The humidification mechanism is provided, for example, between the filter 11 and the three-way electromagnetic valve 12. The humidification mechanism may be provided, for example, between the gas flow inlet Pa and the filter 11. In the first flow channel 10, the hygrometer 18 is provided at the rear of the three-way electromagnetic valve 12 (between the sensor unit 14 and the needle valve 15, for example).

The MPU 50 is allowed to output, to the humidification mechanism 17, a control signal for controlling an amount of humidification of the humidification mechanism 17 on the basis of humidity data obtained by the hygrometer 18. The humidification mechanism 17 adjusts humidity of the gas flowing through the first flow channel 10 in accordance with the control of the MPU 50.

In this modification example, the humidity of the gas flowing through the first flow channel 10 is adjusted by the humidification mechanism 17. This makes it possible to bring the humidity of the gas flowing through the first flow channel 10 closer to the humidity of the gas flowing through the second flow channel 20, thus allowing for reduction of influence of the humidity on the sensor resistance value Rs. Therefore, it is possible to measure the target component in the gas with good accuracy.

### Modification G

In the embodiment described above and its modification examples, as illustrated in FIG. 19, for example, the flowmeters 13 and 23 may be omitted. Even in such a case, by adjusting the needle valves 15, 21, and 24 in advance so that the flow rate of the evaluation gas and the flow rate of the base gas are equal to each other, it is possible to suppress the generation of noise when switching between the two types of gases. Therefore, it is possible to measure the target component in the gas with good accuracy. In addition, simplification/downsizing and cost reduction of the device becomes possible.

### Modification Example H

In the embodiment described above and its modification examples, as illustrated in FIG. 20, for example, the filter 11 may be omitted. In this case, it is preferable to use clean air that does not contain the target component (or only contains a negligible amount of the target component as compared to the evaluation gas) by, for example, keeping the gas flow inlet Pb as far away from the gas flow inlet Pa as possible. By obtaining, from the gas flow inlet Pb, gas (air) suitable for the base gas to be compared with the evaluation gas, it is possible to measure the target component in the gas with good accuracy. In addition, simplification/downsizing and cost reduction of the device becomes possible.

### Modification Example I

In the embodiment described above and its modification examples, instead of the three-way electromagnetic valves 12 and 22, three-way valves 19 and 26 allowed to be manually opened or closed may be provided, as illustrated in FIG. 21, for example. The three-way valve 19 has one inlet port, two outlet ports, and a manual switching valve for selecting either of the two outlet ports. In the three-way valve 19, the inlet port is coupled to a flow channel 10B, and one of the outlet ports is coupled to the flow channel 10A and another outlet port is coupled to the branched flow channel 31. The three-way valve 26 has one inlet port, two outlet ports, and a manual switching valve for selecting either of the two outlet ports. In the three-way valve 26, the inlet port is coupled to the flow channel 20B, and one of the outlet ports is coupled to the flow channel 20A and another outlet port is coupled to the branched flow channel 32. Even in such a case, it is possible to measure the target component in the gas with good accuracy. In addition, simplification/downsizing and cost reduction of the device becomes possible.

### Modification Example J

In the embodiment described above and its modification examples, some of components in the flow channels 10B and 20B that are provided before the three-way electromagnetic valves 12 and 22 may be rearranged.

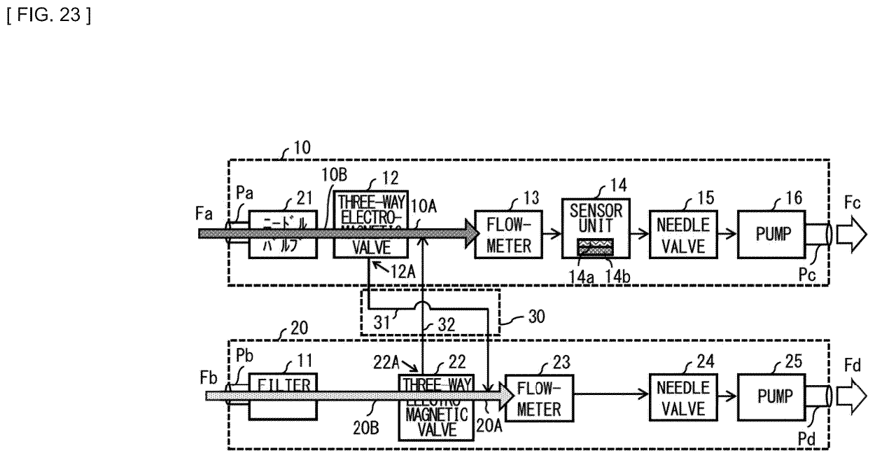

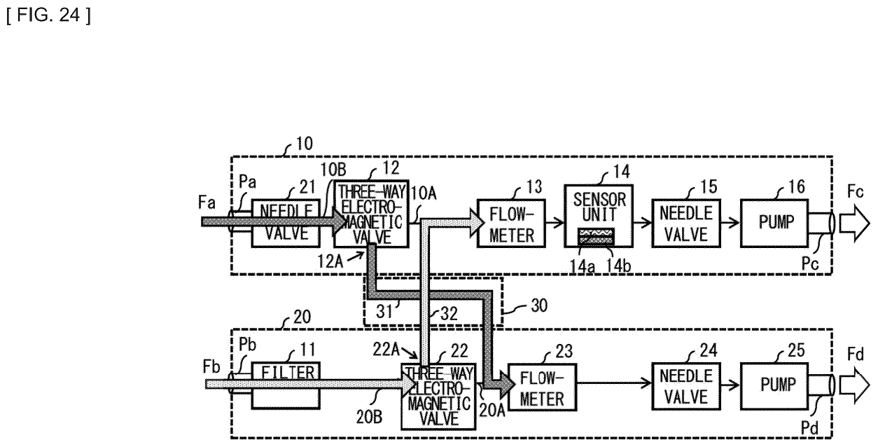

In the gas measuring device 100 described in FIG. 2, the filter 11 and the needle valve 21 may be interchanged, as illustrated in FIG. 22, for example. At this time, the evaluation gas flows through the flow channel 10A when the three-way electromagnetic valves 12 and 22 are set in “straight flow channels”, as illustrated in FIG. 23, for example. In addition, the base gas flows through the flow channel 10A when the three-way electromagnetic valves 12 and 22 are set in “branched flow channels”, as illustrated in FIG. 24, for example.

### Gas Measurement Procedure

In the following, a description is given of the gas measurement procedure in the gas measuring device 100 according to this modification example.

The control circuits 41 and 42 judge whether the base gas measurement period Δta is to be started or not. In a case in which the control circuits 41 and 42 obtain the start signal for the base gas measurement period Δta from the MPU 50, for example, the control circuits 41 and 42 determine that the base gas measurement period Δta is to be started, and output, to the three-way electromagnetic valves 12 and 22, the control signal for setting the three-way electromagnetic valves 12 and 22 in the straight flow channels. In a case in which the control signal for setting the three-way electromagnetic valves 12 and 22 in the straight flow channels is input from the control circuits 41 and 42, the three-way electromagnetic valves 12 and 22 are set in the straight flow channels. That is, in the three-way electromagnetic valve 12, the control circuit 41 causes the flow channel 10B on the input side of the three-way electromagnetic valve 12 to communicate with the flow channel 10A on the first output side of the three-way electromagnetic valve 12. Furthermore, in the three-way electromagnetic valve 22, the control circuit 42 causes the flow channel 20B on the input side of the three-way electromagnetic valve 22 to communicate with the flow channel 20A on the first output side of the three-way electromagnetic valve 22.

As a result, by the action of the pump 16, the gas Fa that has flowed into the gas flow inlet Pa is drawn into the flowmeter 13, the sensor unit 14, the needle valve 15, and the pump 16 via the filter 11 and the three-way electromagnetic valve 12. At this time, the flow rate of the outside air drawn by the action of the pump 16 being regulated by the needle valve 21, the evaluation gas with the flow rate adjusted is obtained. The sensor unit 14 detects the evaluation gas that has flowed into the sensor unit 14, and outputs a detection signal thereby obtained to the output circuit 60.

In contrast, by the action of the pump 25, the gas Fb that has flowed into the gas flow inlet Pb is drawn into the flowmeter 23, the needle valve 24, and the pump 25 via the needle valve 21 and the three-way electromagnetic valve 22. At this time, the outside air drawn by the action of the pump 25 being purified by the filter 11, the base gas is obtained.

The control circuits 41 and 42 judge whether the base gas measurement period Δtb is to be started or not. In a case in which the control circuits 41 and 42 obtain the start signal for the base gas measurement period Δtb from the MPU 50, for example, the control circuits 41 and 42 determine that the evaluation gas measurement period Δtb is to be started, and output, to the three-way electromagnetic valves 12 and 22, the control signal for setting the three-way electromagnetic valves 12 and 22 in the branched flow channels. In a case in which the control signal for setting the three-way electromagnetic valves 12 and 22 in the branched flow channels is input from the control circuits 41 and 42, the three-way electromagnetic valves 12 and 22 are set in the branched flow channels (step S104). That is, in the three-way electromagnetic valve 12, the control circuit 41 causes the flow channel 10B on the input side of the three-way electromagnetic valve 12 to communicate with the flow channel (branched flow channel 31) on the second output side of the three-way electromagnetic valve 12. Furthermore, in the three-way electromagnetic valve 22, the control circuit 42 causes the flow channel 20B on the input side of the three-way electromagnetic valve 22 to communicate with the flow channel (branched flow channel 32) on the second output side of the three-way electromagnetic valve 22.

As a result, by the action of the pump 25, the evaluation gas that has flowed into the three-way electromagnetic valve 12 is drawn into the second flow channel (specifically, the flowmeter 23, the needle valve 24, and the pump 25) via the branched flow channel 31.

In contrast, by the action of the pump 16, the evaluation gas that has flowed into the three-way electromagnetic valve 22 flows into the first flow channel 10 (specifically, the flowmeter 13, the sensor unit 14, the needle valve 15, and the pump 16) via the branched flow channel 32. At this time, the outside air drawn by the action of the pump 16 being purified by the filter 11, the base gas is obtained. The base gas flows into the sensor unit 14. The sensor unit 14 detects the base gas that has flowed into the sensor unit 14 and outputs a detection signal thereby obtained to the output circuit 60.

The control circuits 41 and 42 alternately perform the control for base gas measurement and the control for evaluation gas measurement, in accordance with the control of the MPU 50. That is, the control circuits 41 and 42 alternately perform the control for base gas measurement and the control for evaluation gas measurement, by opening and closing the three-way electromagnetic valve 12 and the three-way electromagnetic valve 22. At this time, as illustrated in FIG. 8, for example, the sensor resistance value Rs decreases every time the gas sensor 14a (or the gas sensor 14d) is exposed to the evaluation gas and returns to a predetermined value every time the gas sensor 14a (or the gas sensor 14d) is exposed to the base gas.

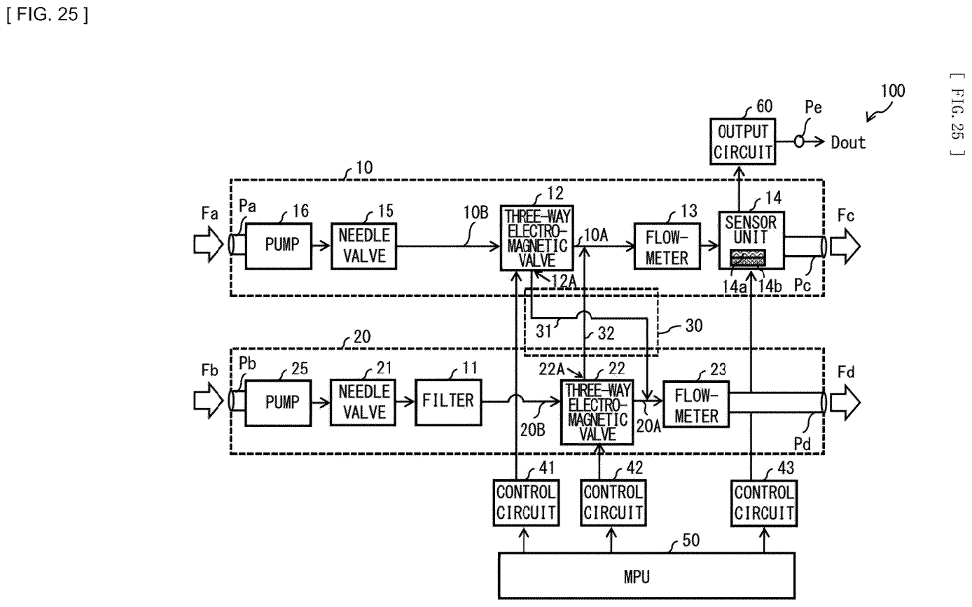

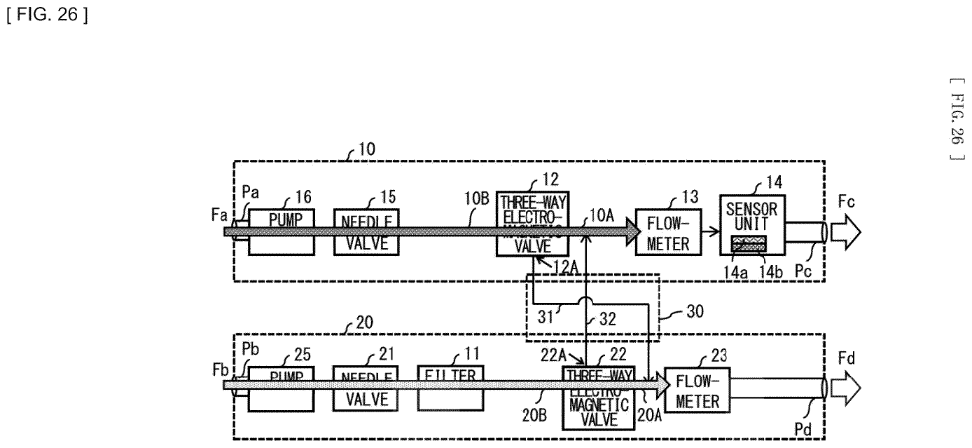

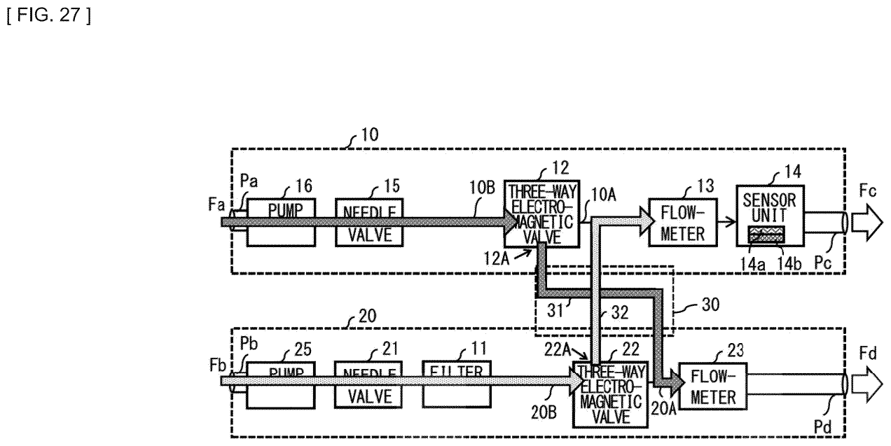

In the gas measuring device 100 described in FIG. 14, the filter 11 may be relocated from the first flow channel (flow channel 10B) to the second flow channel (flow channel 29B), as illustrated in FIG. 25, for example. At this time, the evaluation gas flows through the flow channel 10A when the three-way electromagnetic valves 12 and 22 are set in “straight flow channels”, as illustrated in FIG. 26, for example. In addition, as illustrated in FIG. 27, for example, the base gas flows through the flow channel 10A when the three-way electromagnetic valves 12 and 22 are set in “branched flow channels”. Even in such a case, similarly to the embodiment described above and its modification examples, it is possible to measure the target component in the gas with good accuracy.

### Gas Measurement Procedure

In the following, a description is given of the gas measurement procedure in the gas measuring device 100 according to this modification example.

The control circuits 41 and 42 judge whether the base gas measurement period Δta is to be started or not. In a case in which the control circuits 41 and 42 obtain the start signal for the base gas measurement period Δta from the MPU 50, for example, the control circuits 41 and 42 determine that the base gas measurement period Δta is to be started, and output, to the three-way electromagnetic valves 12 and 22, the control signal for setting the three-way electromagnetic valves 12 and 22 in the straight flow channels. In a case in which the control signal for setting the three-way electromagnetic valves 12 and 22 in the straight flow channels is input from the control circuits 41 and 42, the three-way electromagnetic valves 12 and 22 are set in the straight flow channels. That is, in the three-way electromagnetic valve 12, the control circuit 41 causes the flow channel 10B on the input side of the three-way electromagnetic valve 12 to communicate with the flow channel 10A on the first output side of the three-way electromagnetic valve 12. Furthermore, in the three-way electromagnetic valve 22, the control circuit 42 causes the flow channel 20B on the input side of the three-way electromagnetic valve 22 to communicate with the flow channel 20A on the first output side of the three-way electromagnetic valve 22.

As a result, the gas Fa drawn from the gas flow inlet Pa by the action of the pump 16 flows into the flowmeter 13 and the sensor unit 14 via the needle valve 15, the filter 11, and the three-way electromagnetic valve 12. At this time, the flow rate of the outside air drawn by the action of the pump 16 being regulated by the needle valve 15, the evaluation gas with the flow rate adjusted is obtained. The evaluation gas flows into the sensor unit 14. The sensor unit 14 detects the evaluation gas that has flowed into the sensor unit 14, and outputs a detection signal thereby obtained to the output circuit 60.

In contrast, the gas Fb drawn from the gas flow inlet Pb by the action of the pump 25 flows into the flowmeter 23 via the needle valve 21, the filter 11, and the three-way electromagnetic valve 22. At this time, the outside air drawn by the action of the pump 25 being purified by the filter 11, the base gas is obtained.

The control circuits 41 and 42 judge whether the base gas measurement period Δtb is to be started or not. In a case in which the control circuits 41 and 42 obtain the start signal for the base gas measurement period Δtb from the MPU 50, for example, the control circuits 41 and 42 determine that the evaluation gas measurement period Δtb is to be started, and output, to the three-way electromagnetic valves 12 and 22, the control signal for setting the three-way electromagnetic valves 12 and 22 in the branched flow channels. In a case in which the control signal for setting the three-way electromagnetic valves 12 and 22 in the branched flow channels is input from the control circuits 41 and 42, the three-way electromagnetic valves 12 and 22 are set in the branched flow channels (step S104). That is, in the three-way electromagnetic valve 12, the control circuit 41 causes the flow channel 10B on the input side of the three-way electromagnetic valve 12 to communicate with the flow channel (branched flow channel 31) on the second output side of the three-way electromagnetic valve 12. Furthermore, in the three-way electromagnetic valve 22, the control circuit 42 causes the flow channel 20B on the input side of the three-way electromagnetic valve 22 to communicate with the flow channel (branched flow channel 32) on the second output side of the three-way electromagnetic valve 22.

As a result, the gas Fa drawn from the gas flow inlet Pa by the action of the pump 16 flows into the second flow channel 20 (specifically, the flowmeter 23) via the branched flow channel 31. At this time, the flow rate of the outside air drawn by the action of the pump 16 being regulated by the needle valve 15, the evaluation gas with the flow rate adjusted is obtained.

In contrast, the gas Fb drawn from the gas flow inlet Pb by the pump 25 flows into the first flow channel 10 (specifically, the flowmeter 13 and the sensor unit 14) via the branched flow channel 32. The evaluation gas flows into the sensor unit 14. At this time, the outside air drawn by the action of the pump 25 being purified by the filter 11, the base gas is obtained. The base gas flows into the sensor unit 14. The sensor unit 14 detects the base gas that has flowed into the sensor unit 14 and outputs a detection signal thereby obtained to the output circuit 60.

The control circuits 41 and 42 alternately perform the control for base gas measurement and the control for evaluation gas measurement, in accordance with the control of the MPU 50. That is, the control circuits 41 and 42 alternately perform the control for base gas measurement and the control for evaluation gas measurement, by opening and closing the three-way electromagnetic valve 12 and the three-way electromagnetic valve 22. At this time, as illustrated in FIG. 8, for example, the sensor resistance value Rs decreases every time the gas sensor 14a (or the gas sensor 14d) is exposed to the evaluation gas and returns to a predetermined value every time the gas sensor 14a (or the gas sensor 14d) is exposed to the base gas.

In this modification example, the pump 16 is provided between the gas flow inlet Pa and the filter 11, and the pump 25 is provided between the gas flow inlet Pb and the three-way electromagnetic valve 22. Even in such a case, it is possible to measure the target component in the gas with good accuracy.

In this modification example, the filter 11 is provided in the second flow channel (flow channel 20B). Even in such a case, similarly to the embodiment described above and its modification examples, it is possible to measure the target component in the gas with good accuracy.

### 3. APPLICATION EXAMPLE

In the following, a description is given of an application example of the gas measuring device 100 according to the embodiment described above and its modification examples. FIG. 28 illustrates the application example of the gas measuring device 100 according to the embodiment described above and its modification examples.

In the gas measuring device 100, the output circuit 60 is such configured that communication with a server device 200 is possible via a communication network 300. The communication network 300 is compliant with any standard, for example, LAN (Local Area Network).

As illustrated in FIG. 29, for example, the server device 200 includes a communication unit 210, a signal processor 220, and a storage unit 230. The communication unit 210 is such configured that communication with the gas measuring device 100 is possible via the communication network 300.

The signal processor 220 includes, for example, a CPU (Central Processing Unit), and executes various types of programs (a program 231, for example) stored in the storage unit 230. The signal processor 220 executes a series of procedures described in the program 231 by the program 31 being loaded. The program 231 being loaded, for example, the signal processor 220 derives the target component in the gas on the basis of the data (output data Dout) output from the gas measuring device 100.

The storage unit 230 includes, for example, a non-volatile memory, and includes, for example, an EEPROM (Electrically Erasable Programmable Read-Only Memory), a flash memory, and a resistance random access memory. The program 230 that describes the series of procedures for deriving the target component in the gas is stored in the storage unit 230.

In the gas measuring device 100, the gas sensor 14a and the gas sensor 14d are configured to detect a specific gas emitted from a plant 400. For example, gas molecules of the specific gas emitted from the plant 400 react with oxygen adsorbed on a surface of the gas detection layer 142, resulting in a change in resistance of the gas detection layer 142. This allows the gas detection layer 142 to detect the specific gas released from the plant 400.

Here, the “specific gas” refers to a specific gas to be emitted from a plant when the plant is attacked by disease and pest. Yield losses due to disease and pest are a major problem in the world in terms of food security at the domestic, national, and global levels. Thus, in a case in which plants are cultivated in agriculture, early detection of damages to the plants by disease and pest is critical in minimizing yield losses.

It is known that in a case in which plants are damaged by disease and pest, the plants release volatile molecules called green scents (Green Leaf Volatiles (GLVs)). The green scents are major components of green leaf scents or grassy odor, and approximately nine types of green scents are currently known, including (Z)-3-hexenal, (Z)-3-hexenol, (Z)-3-hexenyl acetate, (E)-2-hexenal, (E)-2-hexenol, (E)-2-hexenyl acetate, n-hexanal, n-hexanol, and n-hexanyl acetate. Besides, it is also known that plants release a volatile chemical substance, such as an herbivore-attracting plant volatile substance (Herbivore-Induced Plant Volatiles (HIPVs)), that is specifically produced when plants are damaged by destructive insects and that serve to attract natural enemies (such as parasitic bees) to herbivore. Many of these are classified as terpenes and terpenoids, and characterized by releasing a blend of odors specific to a type of destructive insect. Examples known include α-pinene, d-limonene, (Z)-β-ocimene, and jasmonic acid.

The signal processor 220 is allowed to identify a difference in scents emitted from plants containing a plurality of volatile molecules, such as presence or absence of the above-mentioned volatile molecules, on the basis of the data (sensor resistance value Rs) obtained from the gas measuring device 100. This allows for early detection of damages of plants to be caused by disease and pest and countermeasures to be taken. Thus, this may contribute to stabilization and efficiency in plant cultivation.

As described above, the present disclosure relates to improvement of productivity per agricultural worker by minimizing food yield losses due to disease and pest, and may contribute to Goal 2 “Zero Hunger” of SDGs (Sustainable Development Goals) adopted in the United Nations Summit in 2015.

### 4. MODIFICATION EXAMPLES

In the following, a description is given of modification examples of the gas measuring device 100 according to the embodiment described above and its modification examples.

### Modification Example 4-1

In the embodiment described above and its modification examples, instead of the gas flow inlet Pb, two gas flow inlets P-1 and P-2 that take in gases Fe-1 and Fe-2 (outside air) may be provided, as illustrated in FIG. 30, for example. The gas flow inlet P-1 and the gas flow inlet P2 are disposed at mutually different locations and are disposed, for example, at two locations spaced apart by a predetermined distance in the gas measuring device 100. At this time, a three-way electromagnetic valve 27 with two inputs and one output is provided in a flow channel 20C between the two gas flow inlets P-1 and P-2 and the needle valve 21, and a control circuit is provided that controls opening and closing of the three-way electromagnetic valve 27 in accordance with the control of the MPU 50.

The three-way electromagnetic valve 27 has two inlet ports, one outlet port, and an electromagnetically driven switching valve for selecting either of the two inlet ports. In the three-way electromagnetic valve 27, one inlet port is coupled to the gas flow inlet P-1, and another inlet port is coupled to the gas flow inlet P-2. The outlet port is coupled to the needle valve 21 via the flow channel 20C.

In this modification example, as illustrated in FIG. 31, for example, a needle valve 21-1 is provided in a flow channel 20D-1 between the gas flow inlet P-1 and one of the inlet ports of the three-way electromagnetic valve 27, and a needle valve 21-2 may be provided in a flow channel 20D-2 between the gas flow inlet P-2 and another inlet port of the three-way electromagnetic valve 27.

The needle valve 21-1 is a throttle valve for adjusting a flow rate of a gas flowing through the flow channel 20D-1. In the needle valve 21-1, turning an adjusting knob to a closing direction decreases the flow rate and turning the adjusting knob to an opening direction increases the flow rate. The needle valve 21-2 is a throttle valve for adjusting a flow rate of a gas flowing through the flow channel 20D-2. In the needle valve 21-2, turning an adjusting knob to the closing direction decreases the flow rate and turning the adjusting knob to the opening direction increases the flow rate.

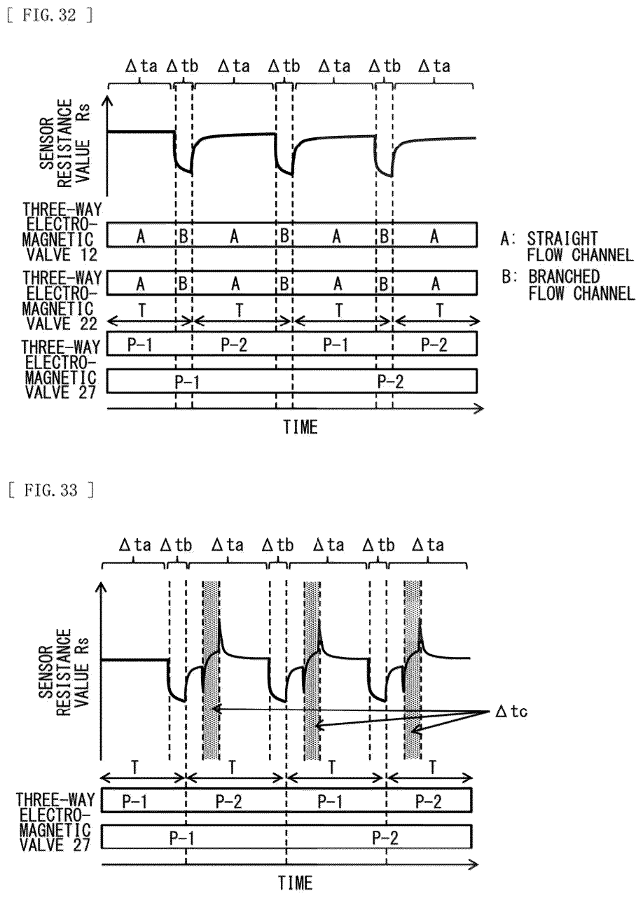

FIG. 32 illustrates an example of a detection signal (sensor resistance value Rs) of the sensor unit 14, and an example of the states of the three three-way electromagnetic valves 12, 22, and 27. The control circuit 47 alternately performs control for measurement of a gas (evaluation gas) flowing from the gas flow inlet P-1 and control for measurement of a gas (evaluation gas) flowing from the gas flow inlet P-2, in accordance with the control of the MPU 50. That is, the control circuit 47 alternately performs the control for measurement of the gas (evaluation gas) flowing from the gas flow inlet P-1 and the control for measurement of the gas (evaluation gas) flowing from the gas flow inlet P-2, by opening and closing the three-way electromagnetic device 27. It is to be noted that FIG. 32 exemplarily illustrates a case in which the three-way electromagnetic valve 27 switches every 2T and a case in which the three-way electromagnetic valve 27 switches every T, where a cycle of the evaluation gas flowing through the branched flow channel 32 via the three-way electromagnetic valve 27 is T. A timing at which the three-way electromagnetic valve 27 switches may be slightly delayed (after several tens of milliseconds have elapsed, for example) from a timing at which the three-way electromagnetic valves 12 and 22 switch from a branched flow channel B to a straight flow channel A. In such a case, disturbance in the flow rate due to the switching of the three-way electromagnetic valve 27 is reduced, and the evaluation gas with a stable flow rate is supplied to the branched flow channel 32.

FIG. 33 illustrates an example of the sensor resistance value Rs and an example of the state of the three-way electromagnetic valve 27 when refreshing of the gas sensor 14a is performed in the gas measuring device 100. Even in this case, the control circuit 47 may alternately perform the control for measurement of the gas (evaluation gas) flowing from the gas flow inlet P-1 and the control for measurement of the gas (evaluation gas) flowing from the gas flow inlet P-2, by opening and closing the three-way electromagnetic device 27. It is to be noted that FIG. 33 exemplarily illustrates a case in which the three-way electromagnetic valve 27 switches every 2T and a case in which the three-way electromagnetic valve 27 switches every T, where the cycle of the evaluation gas flowing through the branched flow channel 32 via the three-way electromagnetic valve 27 is T.

In this modification example, the two gas flow inlets P-1 and P-2 that take in the gas (outside air) are provided, and the measurement of the gas (evaluation gas) flowing from the gas flow inlet P-1 and the measurement of the gas (evaluation gas) flowing from the gas flow inlet P-2 are alternately performed by opening and closing the three-way electromagnetic valve 27. This makes it possible to measure more than one type of outside air as the evaluation gas.

### Modification Example 4-2

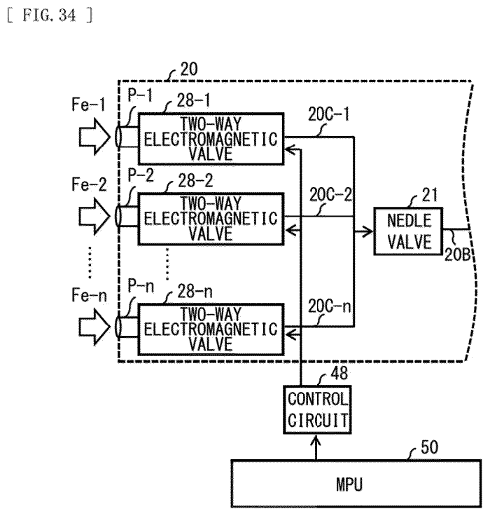

In the embodiment described above and its modification examples, instead of the gas flow inlet Pb, a plurality of (n) gas flow inlets P-1, P-2, . . . , P-n that take in gases Fe-1, Fe-2, . . . , Fe-n (outside air) may be provided, as illustrated in FIG. 34, for example. The plurality of (n) gas flow inlets P-1, P-2, . . . , P-n are disposed at mutually different locations and are disposed, for example, at more than one location spaced apart by a predetermined distance in the gas measuring device 100. At this time, two-way electromagnetic valves 28-1, 28-2, . . . , 28-n are each provided at each of the gas flow inlets P-1, P-2, . . . , P-n, and a control circuit 48 is provided that controls opening and closing of the two-way electromagnetic valves 28-1, 28-2, . . . , 28-n provided at each of the gas flow inlets P-1, P-2, . . . , P-n, in accordance with the control of the MPU 50. The control circuit 48 performs control for opening and closing the plurality of (n) two-way electromagnetic valves 28-1, 28-2, . . . , 28-n in sequence.

For example, a two-way electromagnetic valve 28-1 is provided in a flow channel 20C-1 between the gas flow inlet P-1 and the needle valve 21. For example, a two-way electromagnetic valve 28-2 is provided in a flow channel 20C-2 between the gas flow inlet P-2 and the needle valve 21. For example, a two-way electromagnetic valve 28-n is provided in a flow channel 20C-n between the gas flow inlet P-n and the needle valve 21.

The two-way electromagnetic valves 28-1, 28-2, . . . , 28-n have each one inlet port, one outlet port, and an electromagnetically driven on-off valve that connects the inlet port and the outlet port. In the two-way electromagnetic valves 28-1, 28-2, . . . , 28-n, the inlet port is coupled to the gas flow inlets P-1, P-2 . . . , P-n, and the outlet port is coupled to the flow channels 20C-1, 20C-2, . . . , 20C-n.

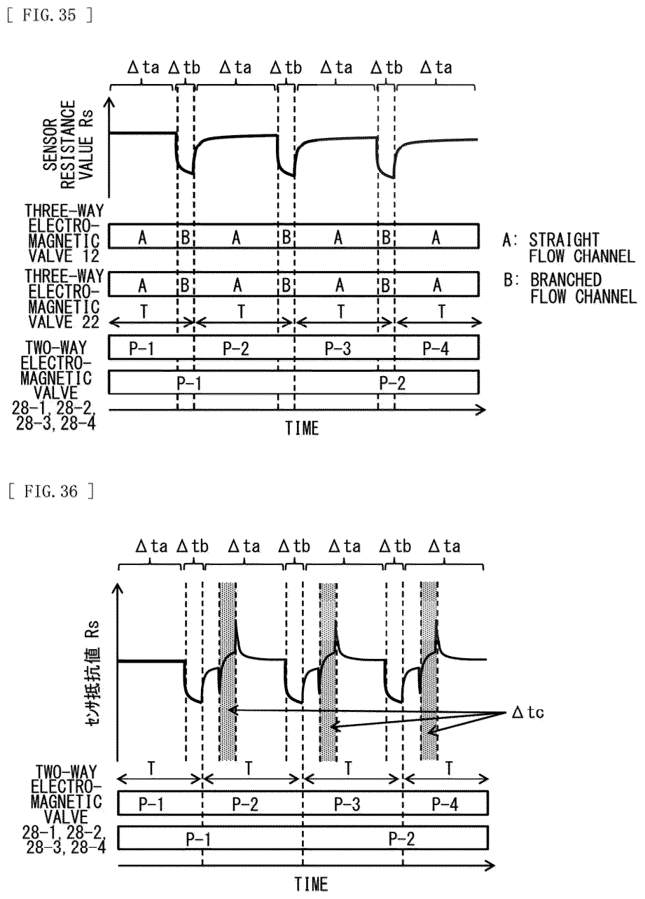

FIG. 35 illustrates an example of a detection signal (sensor resistance value Rs) of the sensor unit 14 and an example of the states of the two-way electromagnetic valves 28-1, 28-2, 28-3, and 28-4 of the two two-way electromagnetic valves 12 and 22. In accordance with the control of the MPU, the control circuit 48 performs, in sequence, the control for measurement of the gas Fe-1 (evaluation gas) flowing from the gas flow inlet P-1, the control for measurement of the gas Fe-2 (evaluation gas) flowing from the gas flow inlet P-2, the control for measurement of the gas Fe-3 (evaluation gas) flowing from the gas flow inlet P-4, and the control for measurement of the gas Fe-4 (evaluation gas) flowing from the gas flow inlet P-4. That is, by opening and closing the four two-way electromagnetic valve 28-1, 28-2, 28-3, . . . , 28-4, the control circuit 48 alternately performs the control for measurement of the gas Fe-1 (evaluation gas) flowing from the gas flow inlet P-1, the control for measurement of the gas Fe-2 (evaluation gas) flowing from the gas flow inlet P-2, the control for measurement of the gas Fe-3 (evaluation gas) flowing from the gas flow inlet P-3, and the control for measurement of the gas Fe-4 (evaluation gas) flowing from the gas flow inlet P-4.

It is to be noted that FIG. 35 exemplarily illustrates a case in which the four two-way electromagnetic valves 28-1, 28-2, 28-3, . . . , 28-4 switch every 2T and a case in which the four two-way electromagnetic valves 28-1, 28-2, 28-3, . . . , 28-4 switch every T, where the cycle of the evaluation gas flowing through the branched flow channel 32 via the three-way electromagnetic valve 22 is T. A timing at which the four two-way electromagnetic valves 28-1, 28-2, 28-3, and 28-4 switch may be slightly delayed (after several tens of milliseconds have elapsed, for example) from a timing at which the three-way electromagnetic valves 12 and 22 switch from the branched flow channel B to the straight flow channel A. In such a case, disturbance in the flow rate due to the switching of the four two-way electromagnetic valves 28-1, 28-2, 28-3, and 28-4 is reduced, and the evaluation gas with a stable flow rate is supplied to the branched flow channel 32.

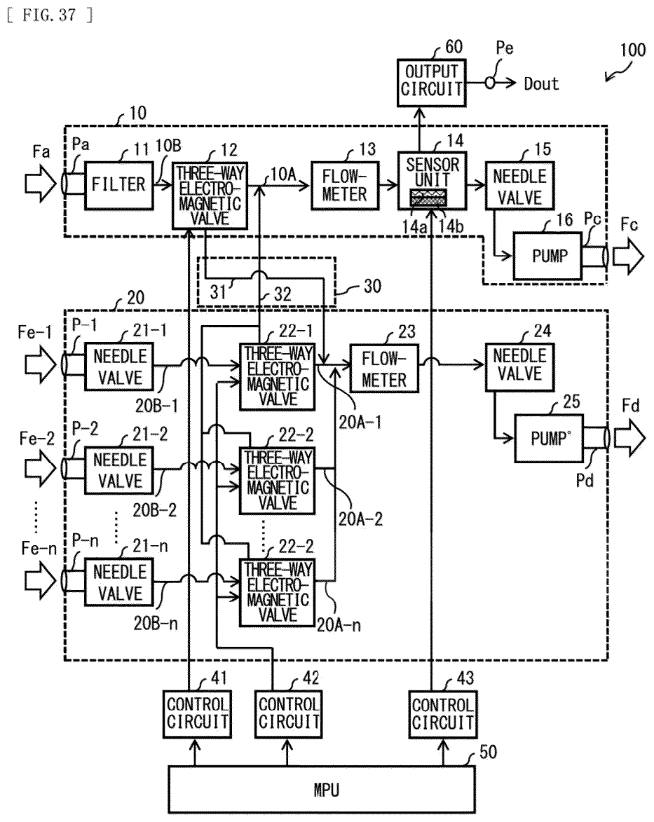

FIG. 36 illustrates an example of the sensor resistance value Rs and an example of the state of the three-way electromagnetic valve 27 when refreshing of the gas sensor 14a is performed in the gas measuring device 100. Even in this case, by opening and closing the four two-way electromagnetic valves 28-1, 28-2, 28-3, and 28-4, the control circuit 48 may perform, in sequence, the control for measurement of the gas Fe-1 (evaluation gas) flowing from the gas flow inlet P-1, the control for measurement of the gas Fe-3 (evaluation gas) flowing from the gas flow inlet P-3, and the control for measurement of the gas Fe-4 (evaluation gas) flowing from the gas flow inlet P-4. It is to be noted that FIG. 36 exemplarily illustrates a case in which the four two-way electromagnetic valves 28-1, 28-2, 28-3, . . . , 28-4 switch every 2T and a case in which the four two-way electromagnetic valves 28-1, 28-2, 28-3, . . . , 28-4 switch every T, where the cycle of the evaluation gas flowing through the branched flow channel 32 via the three-way electromagnetic valve 22 is T.

In this modification example, the plurality of (n) gas flow inlets P-1, P-2, . . . , P-n that take in the gas (outside air) is provided, and measurement of the gases Fe-1, Fe-2, . . . , Fe-3 that flow from the plurality of (n) gas flow inlets P-1, P-2, . . . , P-3 is performed in sequence, by opening and closing the two-way electromagnetic valves 28-1, 28-2, . . . , 28-n. This makes it possible to measure more than one type of outside air as the evaluation gas.

### Modification Example 4-3

In the embodiment described above and its modification examples, as illustrated in FIG. 37, for example, the gas measuring device 100 may include the plurality of (n) as flow inlets P-1, P-2, . . . , P-n that take in the plurality of gases (outside air) Fe-1, Fe-2, . . . , Fe-n, instead of the gas flow inlet Pb. At this time, the gas measuring device 100 includes the plurality of (n) needle valves 21-1, 21-2, . . . , 21-n, each being provided in each of the gas flow inlets P-1, P-2, . . . , P-n. The gas measuring device 100 further includes a plurality of (n) three-way electromagnetic valves 22-1, 22-2, . . . , 22-n, each being provided in each of the gas flow inlets P-1, P-2, . . . , P-n.

The plurality of (n) gas flow inlets P-1, P-2, . . . , P-n are disposed at mutually different locations and are disposed, for example, at more than one (n) location spaced apart by a predetermined distance in the gas measuring device 100. The three-way electromagnetic valves 22-1, 22-2, . . . , 22-n are each provided at each of the gas flow inlets P-1, P-2, . . . , P-n, and the control circuit 42 is provided that controls opening and closing of the plurality of (n) three-way electromagnetic valves 22-1, 22-2, . . . , 22-n that is provided at each of the gas flow inlets P-1, P-2, . . . , P-n, in accordance with the control of the MPU 50. The control circuit 48 performs control for opening and closing the plurality of (n) two-way electromagnetic valves 28-1, 28-2, . . . , 28-n in sequence.

The three-way electromagnetic valves 22-1, 22-2, . . . , 22-n each has one inlet port, two outlet ports, and an electromagnetically driven switching valve for selecting either of the two outlet ports. In the three-way electromagnetic valves 22-1, 22-2, . . . , 22-n, the inlet port is coupled to flow channels 20B-1, 20B-2. ..., 22B-n, and another outlet port is coupled to flow channel 20A-1, 20A-2, . . . , 20A-n. The other outlet port is coupled to the branched flow channel 32. The flow channels 20B-1, 20B-2, . . . , 20B-n are coupled to the gas flow inlets P-1, P-2, . . . , P-n via the needle valves 21-1, 21-2, . . . , 21-n.

In this modification example, the plurality of (n) gas flow inlets P-1, P-2, . . . , P-n that take in the gases Fe-1, Fe-2, . . . P-n (outside air) is provided. By opening and closing the three-way electromagnetic valves 2201, 22-1, ..., 22-n, measurement of the gases Fe-1, Fe-2, . . . , Fe-n (evaluation gas) flowing from the plurality of (n) gas flow inlets P-1, P-2, . . . , P-n is performed in sequence. This makes it possible to measure more than one type of outside air as the evaluation gas.

Although the present disclosure has been described above by way of the embodiment and its modification examples, and the application example, the present disclosure is not limited to the above embodiment, or the like, and various modifications are possible. It is to be noted that the effects described herein are merely examples. The effects of the present disclosure are not limited to the effects described herein. The preset disclosure may have effects other than those described herein.

It should be understood by those skilled in the art that various modifications, combinations, sub-combinations and alterations may occur depending on design requirements and other factors insofar as they are within the scope of the appended claims or the equivalents thereof.

In addition, the present disclosure may have the following configurations:
(1)

A Gas Measuring Device Including:
a first flow channel having a first three-way valve with one input and two outputs, a gas detector coupled to a first output of the first three-way valve, and a first pump coupled to the first output or an input of the first three-way valve;
a second flow channel having a second three-way valve with one input and two outputs and a second pump coupled to a first output or an input of the second three-way valve;
a first branched flow channel coupled to a second output of the first three-way valve and the first output of the second three-way valve; and
a second branched flow channel coupled to a second output of the second three-way valve and the first output of the first three-way valve.
(2)

The gas measuring device according to (1), in which
the first flow channel has a first inlet port that directly takes in outside air, and no mechanism is provided between the first inlet port and first three-way valve in the first flow channel, the mechanism mixing a predetermined gas with the outside air taken in from the first inlet port, and
the second flow channel has a second inlet port that directly takes in outside air, at a location different from the first inlet port, and no mechanism is provided between the second inlet port and the second three-way valve in the second flow channel, the mechanism mixing a predetermined gas with the outside air taken in from the second inlet port.
(3)

The gas measuring device according to (2), in which
the first flow channel has a filter between the first inlet port and the first three-way valve for purifying the outside air taken in from the first inlet port, and
the second flow channel has a valve between the second inlet port and the second three-way valve for regulating a flow rate of the outside air taken in from the first inlet port.
(4)

The gas measuring device according to any one of (1) to (3), in which
the first three-way valve and the second three-way valve each have a mechanism configured to open and close the valve, and
the gas measuring device further includes a control unit that is configured to control the opening and closing of the first three-way valve and the second three-way valve.
(5)

The gas measuring device according to (4), in which
the gas detector includes a gas sensor provided in the first flow channel, and a heater that heats the gas sensor, and
the control unit is configured to adjust temperature of the gas sensor by controlling the heater.
(6)

The gas measuring device according to (5), in which
the control unit is configured to exert control for refreshing the gas sensor over the heater.
(7)

The gas measuring device according to (4), in which
the first flow channel has a first flowmeter and a first valve,
the second flow channel has a second flowmeter and a second valve, and
the control unit is configured to control the first valve and the second valve on a basis of measurement data of each of the first flowmeter and the second flowmeter.
(8)

The gas measuring device according to (4), in which
the first flow channel further includes a humidification mechanism and a hygrometer, and
the control unit is configured to control the humidification mechanism on the basis of measurement data of the hygrometer.
(9)

A gas measuring system including:
a first flow channel having a first three-way valve with one input and two outputs, a gas detector coupled to a first output of the first three-way valve, and a first pump coupled to the first output or an input of the first three-way valve;
a second flow channel having a second three-way valve with one input and two outputs and a second pump coupled to a first output or an input of the second three-way valve;
a first branched flow channel coupled to a second output of the first three-way valve and the first output of the second three-way valve;
a second branched flow channel coupled to a second output of the second three-way valve and the first output of the first three-way valve; and
a signal processor that processes a detection signal of the gas detector.
(10)

A gas measuring method including:
a first sensing step, in which in a first three-way valve with one input and two outputs, the input of the first three-way valve is caused to communicate with a first output of the first three-way valve, and in a second three-way valve with one input and two outputs, the input of the second three-way valve is caused to communicate with a first output of the second three-way valve, and then, by action of a first pump, a first gas is drawn through the first three-way valve into a first flow channel including a gas sensor, and by action of a second pump, a second gas is drawn through the second three-way valve into a second flow channel; and
a second sensing step, in which in the first three-way valve, the input of the first three-way valve is caused to communicate with a second output of the first three-way valve, and in the second three-way valve, the input of the second three-way valve is caused to communicate with a second output of the second three-way valve, and then, by the action of the second pump, the first gas is drawn through the first three-way valve into the second flow channel, and by the action of the first pump, the second gas is drawn through the first three-way valve into the first flow channel,
the method including:
alternately performing the first sensing step and the second sensing step by opening and closing the first three-way valve and the second three-way valve.
(11)

The gas measuring method according to (10) including:
in the first sensing step, purifying outside air drawn by the action of the first pump with a filter, thereby obtaining the first gas, and regulating a flow rate of outside air drawn by the action of the second pump with a valve, thereby obtaining the second gas with a flow rate adjusted; and
in the second sensing step, purifying outside air drawn by the action of the second pump with the filter, thereby obtaining the first gas, and regulating a flow rate of outside air drawn by the action of the first pump with the valve, thereby obtaining the second gas with a flow rate adjusted.
(12)

The gas measuring method according to (10) including:
in the first sensing step, purifying outside air drawn by the action of the second pump with a filter, thereby obtaining the second gas, and regulating a flow rate of outside air drawn by the action of the first pump with a valve, thereby obtaining the first gas with a flow rate adjusted; and
in the second sensing step, purifying outside air drawn by the action of the first pump with the filter, thereby obtaining the second gas, and regulating a flow rate of outside air drawn by the action of the second pump with the valve, thereby obtaining the first gas with a flow rate adjusted.
(13)

The gas measuring method according to any one of (10) to (12) including:
refreshing the gas sensor by heating, in the first sensing step.
(14)

A gas measuring method including:
a first sensing step, in which in a first three-way valve with one input and two outputs, the input of the first three-way valve is caused to communicate with a first output of the first three-way valve, and in a second three-way valve with one input and two outputs, an input of the second three-way valve is caused to communicate with a first output of the second three-way valve, and then, a first gas drawn by action of a first pump flows through the first three-way valve into a first flow channel including a gas sensor, and a second gas drawn by action of a second pump flows through the second three-way valve into a second flow channel; and
a second sensing step, in which in the first three-way valve, the input of the first three-way valve is caused to communicate with a second output of the first three-way valve, and in the second three-way valve, the input of the second three-way valve is caused to communicate with a second output of the second three-way valve, and then, the first gas drawn by the action of the first pump flows through the first three-way valve into the second flow channel, and the second gas drawn by the action of the second pump flows through the first three-way valve into the first flow channel;
the method including:
alternately performing the first sensing step and the second sensing step by opening and closing the first three-way valve and the second three-way valve.
(15)

The gas measuring method according to (14) including:
in the first sensing step, purifying outside air drawn by the action of the first pump with a filter, thereby obtaining the first gas, and regulating a flow rate of outside air drawn by the action of the second pump with a valve, thereby obtaining the second gas with a flow rate adjusted; and
in the second sensing step, purifying outside air drawn by the action of the first pump with the filter, thereby obtaining the first gas, and regulating a flow rate of outside air drawn by the action of the second pump with the valve, thereby obtaining the second gas with a flow rate adjusted.
(16)

The gas measuring method according to (14), in which
in the first sensing step, purifying outside air drawn by the action of the second pump with a filter, thereby obtaining the second gas, and regulating a flow rate of outside air drawn by the action of the first pump with a valve, thereby obtaining the first gas with a flow rate adjusted; and
in the second sensing step, purifying outside air drawn by the action of the first pump with the filter, thereby obtaining the second gas, and regulating a flow rate of outside air drawn by the action of the second pump with the valve, thereby obtaining the first gas with a flow rate adjusted.
(17)

The gas measuring method according to any one of (14) to (16), in which
refreshing the gas sensor by heating, in the first sensing step.

This application claims priority based on Japanese Patent Application No. 2022-196195 filed on Dec. 8, 2022 with Japan Patent Office, the entire contents of which are incorporated in this application by reference.

It should be understood by those skilled in the art that various modifications, combinations, sub-combinations and alterations may occur depending on design requirements and other factors insofar as they are within the scope of the appended claims or the equivalents thereof.

1. A gas measuring device comprising:
a first flow channel including a first three-way valve with one input and two outputs, a gas detector coupled to a first output of the first three-way valve, and a first pump coupled to the first output or an input of the first three-way valve;
a second flow channel including a second three-way valve with one input and two outputs and a second pump coupled to a first output or an input of the second three-way valve;
a first branched flow channel coupled to a second output of the first three-way valve and the first output of the second three-way valve; and
a second branched flow channel coupled to a second output of the second three-way valve and the first output of the first three-way valve.

2. The gas measuring device according to claim 1, wherein
the first flow channel includes a first inlet port that directly takes in outside air, and no mechanism is provided between the first inlet port and first three-way valve in the first flow channel, the mechanism mixing a predetermined gas with the outside air taken in from the first inlet port, and
the second flow channel has a second inlet port that directly takes in outside air, at a location different from the first inlet port, and no mechanism is provided between the second inlet port and the second three-way valve in the second flow channel, the mechanism mixing a predetermined gas with the outside air taken in from the second inlet port.

3. The gas measuring device according to claim 2, wherein
the first flow channel includes a filter between the first inlet port and the first three-way valve for purifying the outside air taken in from the first inlet port, and
the second flow channel includes a valve between the second inlet port and the second three-way valve for regulating a flow rate of the outside air taken in from the first inlet port.

4. The gas measuring device according to claim 1, wherein
the first three-way valve and the second three-way valve each include a mechanism configured to open and close the valve, and
the gas measuring device further comprises a control unit that is configured to control the opening and closing of the first three-way valve and the second three-way valve.

5. The gas measuring device according to claim 4, wherein
the gas detector includes a gas sensor provided in the first flow channel, and a heater that heats the gas sensor, and
the control unit is configured to adjust temperature of the gas sensor by controlling the heater.

6. The gas measuring device according to claim 5, wherein
the control unit is configured to exert control for refreshing the gas sensor over the heater.

7. The gas measuring device according to claim 4, wherein
the first flow channel includes a first flowmeter and a first valve,
the second flow channel includes a second flowmeter and a second valve, and
the control unit is configured to control the first valve and the second valve on a basis of measurement data of each of the first flowmeter and the second flowmeter.

8. The gas measuring device according to claim 4, wherein
the first flow channel further includes a humidification mechanism and a hygrometer, and
the control unit is configured to control the humidification mechanism on the basis of measurement data of the hygrometer.

9. A gas measuring system comprising:
a first flow channel including a first three-way valve with one input and two outputs, a gas detector coupled to a first output of the first three-way valve, and a first pump coupled to the first output or an input of the first three-way valve;
a second flow channel including a second three-way valve with one input and two outputs and a second pump coupled to a first output or an input of the second three-way valve;
a first branched flow channel coupled to a second output of the first three-way valve and the first output of the second three-way valve;
a second branched flow channel coupled to a second output of the second three-way valve and the first output of the first three-way valve; and
a signal processor that processes a detection signal of the gas detector.

10. A gas measuring method comprising:
a first sensing step, in which in a first three-way valve with one input and two outputs, the input of the first three-way valve is caused to communicate with a first output of the first three-way valve, and in a second three-way valve with one input and two outputs, the input of the second three-way valve is caused to communicate with a first output of the second three-way valve, and then, by action of a first pump, a first gas is drawn through the first three-way valve into a first flow channel including a gas sensor, and by action of a second pump, a second gas is drawn through the second three-way valve into a second flow channel; and
a second sensing step, in which in the first three-way valve, the input of the first three-way valve is caused to communicate with a second output of the first three-way valve, and in the second three-way valve, the input of the second three-way valve is caused to communicate with a second output of the second three-way valve, and then, by the action of the second pump, the first gas is drawn through the first three-way valve into the second flow channel, and by the action of the first pump, the second gas is drawn through the first three-way valve into the first flow channel;
the method including:
alternately performing the first sensing step and the second sensing step by opening and closing the first three-way valve and the second three-way valve.

11. The gas measuring method according to claim 10, further comprising:
in the first sensing step, purifying outside air drawn by the action of the first pump with a filter, thereby obtaining the first gas, and regulating a flow rate of outside air drawn by the action of the second pump with a valve, thereby obtaining the second gas with a flow rate adjusted; and
in the second sensing step, purifying outside air drawn by the action of the second pump with the filter, thereby obtaining the first gas, and regulating a flow rate of outside air drawn by the action of the first pump with the valve, thereby obtaining the second gas with a flow rate adjusted.

12. The gas measuring method according to claim 10, further comprising:
in the first sensing step, purifying outside air drawn by the action of the second pump with a filter, thereby obtaining the second gas, and regulating a flow rate of outside air drawn by the action of the first pump with a valve, thereby obtaining the first gas with a flow rate adjusted; and
in the second sensing step, purifying outside air drawn by the action of the first pump with the filter, thereby obtaining the second gas, and regulating a flow rate of outside air drawn by the action of the second pump with the valve, thereby obtaining the first gas with a flow rate adjusted.

13. The gas measuring method according to claim 10, further comprising:
refreshing the gas sensor by heating, in the first sensing step.

14. A gas measuring method comprising:
a first sensing step, in which in a first three-way valve with one input and two outputs, the input of the first three-way valve is caused to communicate with a first output of the first three-way valve, and in a second three-way valve with one input and two outputs, an input of the second three-way valve is caused to communicate with a first output of the second three-way valve, and then, a first gas drawn by action of a first pump flows through the first three-way valve into a first flow channel including a gas sensor, and a second gas drawn by action of a second pump flows through the second three-way valve into a second flow channel; and
a second sensing step, in which in the first three-way valve, the input of the first three-way valve is caused to communicate with a second output of the first three-way valve, and in the second three-way valve, the input of the second three-way valve is caused to communicate with a second output of the second three-way valve, and then, the first gas drawn by the action of the first pump flows through the first three-way valve into the second flow channel, and the second gas drawn by the action of the second pump flows through the first three-way valve into the first flow channel;
the method including:
alternately performing the first sensing step and the second sensing step by opening and closing the first three-way valve and the second three-way valve.

15. The gas measuring method according to claim 14, further comprising:
in the first sensing step, purifying outside air drawn by the action of the first pump with a filter, thereby obtaining the first gas, and regulating a flow rate of outside air drawn by the action of the second pump with a valve, thereby obtaining the second gas with a flow rate adjusted; and
in the second sensing step, purifying outside air drawn by the action of the first pump with the filter, thereby obtaining the first gas, and regulating a flow rate of outside air drawn by the action of the second pump with the valve, thereby obtaining the second gas with a flow rate adjusted.

16. The gas measuring method according to claim 14, further comprising
in the first sensing step, purifying outside air drawn by the action of the second pump with a filter, thereby obtaining the second gas, and regulating a flow rate of outside air drawn by the action of the first pump with a valve, thereby obtaining the first gas with a flow rate adjusted; and
in the second sensing step, purifying outside air drawn by the action of the first pump with the filter, thereby obtaining the second gas, and regulating a flow rate of outside air drawn by the action of the second pump with the valve, thereby obtaining the first gas with a flow rate adjusted.

17. The gas measuring method according to claim 14, wherein the first sensing step comprises refreshing the gas sensor by heating.
